(19) United States
(12) Patent Application Publication
(10) Pub. No.: US 2026/0061594 A1
(43) Pub. Date: Mar. 5, 2026

(54) DISHWASHER LOADING AND UNLOADING ROBOT

(71) Applicant: Clutterbot, Inc., Claymont, DE (US)

(72) Inventor: Justin David Hamilton, Wellington (NZ)

(73) Assignee: Clutterbot, Inc., Claymont, DE (US)

(21) Appl. No.: 19/315,315

(22) Filed: Aug. 29, 2025

Related U.S. Application Data
(60) Provisional application No. 63/688,607, filed on Aug. 29, 2024.

(51) Int. Cl. B25J 9/00; A47L 7/00; B25J 5/00

(52) U.S. Cl. CPC B25J 9/0003; B25J 5/00; A47L 7/0085

(57) ABSTRACT

A tidying robot is used to place and remove a target object, such as a cup, plate or cutlery item, at another location. The robot extends and rotates pusher pads to grasp the target object, and then retracts the pusher pads to move the target object into a scoop. The robot then transports the target object to a destination, such as a dishwasher or storage platform, where it is placed on a storage platform. The robot may also sort items, such as the cutlery and place it into cutlery tray slots.

This application claims the benefit of U.S. provisional patent application Ser. No. 63/688,607, filed on Aug. 29, 2024, the contents of which are incorporated herein by reference in their entirety.

### BACKGROUND

Obstructions or objects underfoot represent not only a nuisance but also a safety hazard. Thousands of people each year are injured in a fall at home. A floor cluttered with loose objects may represent a danger, but many people have limited time in which to address the clutter in their homes. Automated cleaning or tidying robots may represent an effective solution.

Tidying robots conventionally organize objects into standard categories based on an object's type and other attributes that may be determined with classification. However, conventional robotic tidying solutions may be limited in their capabilities, and may be unable to autonomously complete a comprehensive cleaning operation without additional manual work by the user.

There is, therefore, a need for a general purpose tidying robot capable of complex and comprehensive housework operations.

A method for using a robot to load an object into a device or remove the object from the device is described. The method involves approaching a target object with a robot that is equipped with a capture and containment system including a scoop, pusher pads, pusher pad arms, a gripper arm, and a lifting column.

The robot raises the capture and containment system to a grabbing height, extends the pusher pads, rotates the first pusher pad towards the scoop, and approaches the target object, coming to a stop when it contacts the pusher pad. The robot then rotates the second pusher pad to grasp the object, retracts the pusher pad arms, exerts pressure to hold the object in place, and raises the scoop, pusher pads, and lifting column to a carrying position.

In some embodiments, the robot may open an access panel using the gripper arm, partially pull out a storage platform, and extend the pusher pads to position the target object below the pusher pads. The robot then lowers the pusher pads, rotates the pusher pads to contact the target object, and lifts the target object to the containment area.

After holding the target object, the robot may transport it to a second destination. The robot may then place the containment area near a target surface, release the target object onto the surface, and remove the containment area.

In the case of a collection of cutlery items, release the items onto the surface, and sort the cutlery items by category. The sorted cutlery items may be placed in a slot of a cutlery tray.

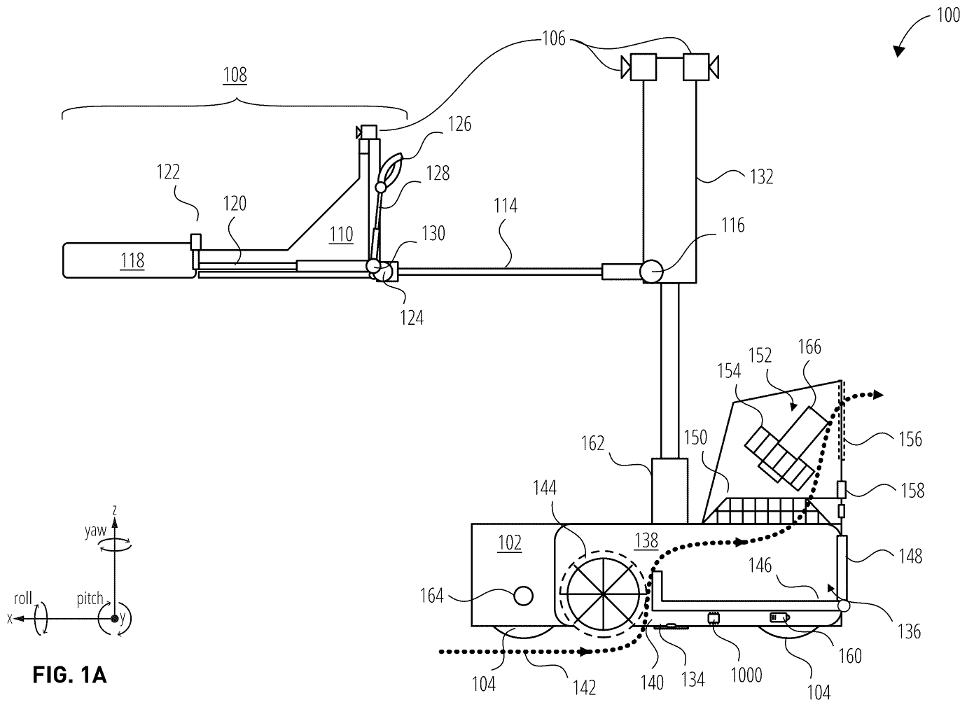

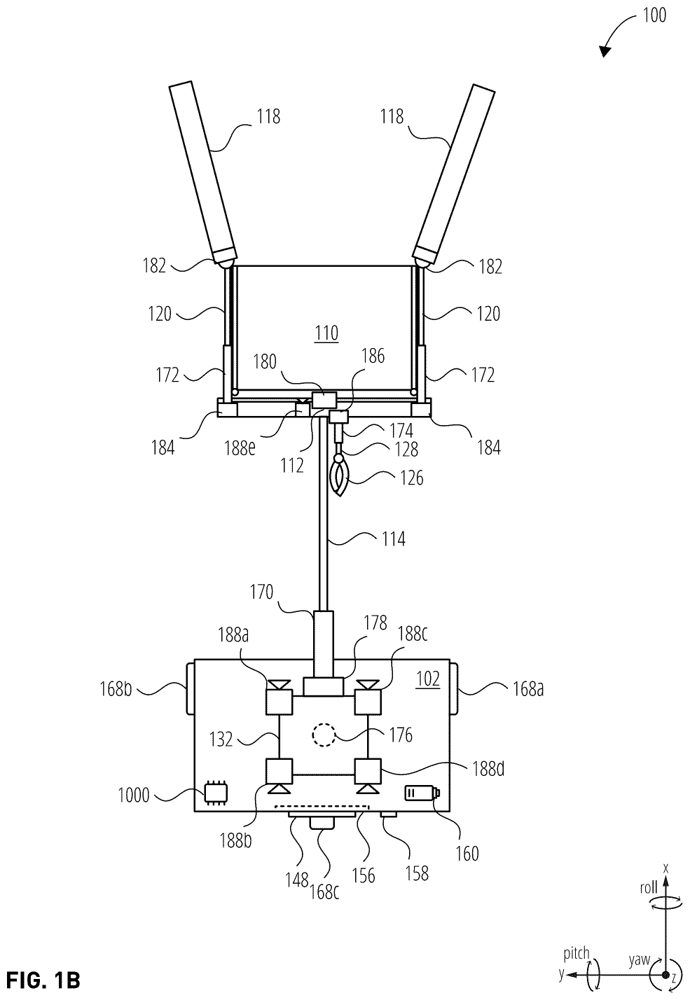

FIG. 1A and FIG. 1B illustrate a tidying robot 100 in accordance with one embodiment. FIG. 1A shows a side view and FIG. 1B shows a top view.

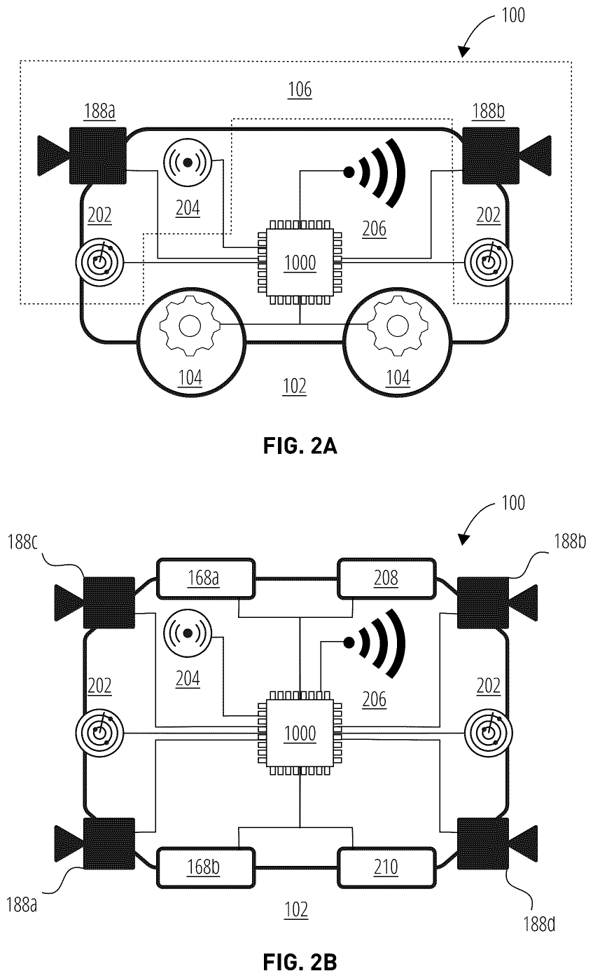

FIG. 2A and FIG. 2B illustrate a simplified side view and top view of a chassis 102 of the tidying robot 100, respectively.

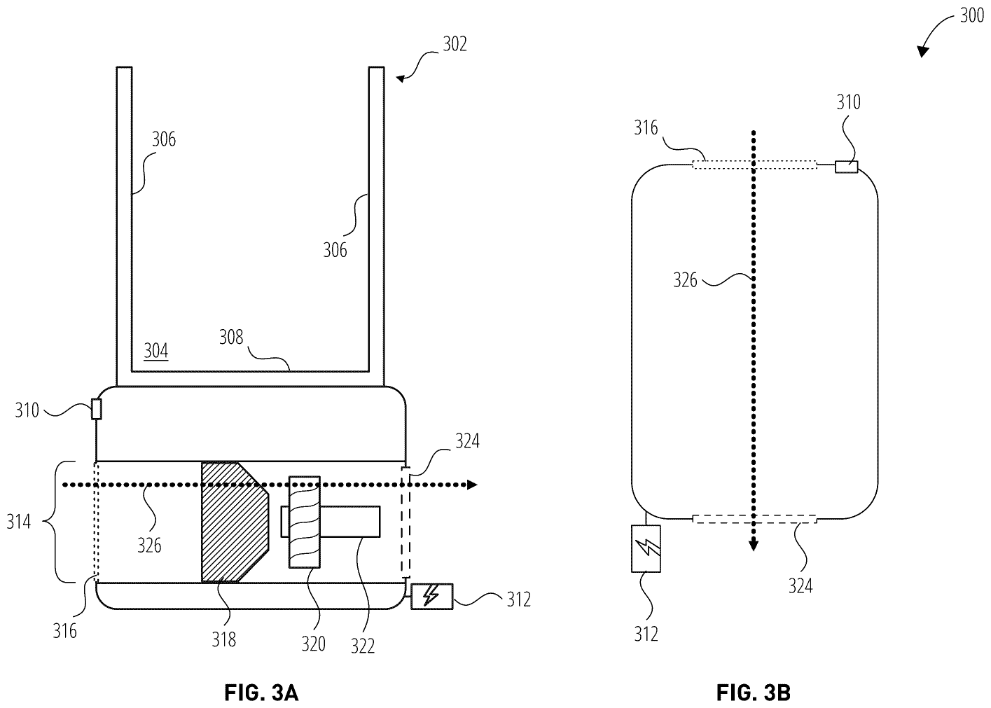

FIG. 3A and FIG. 3B illustrate a left side view and a top view of a base station 300, respectively, in accordance with one embodiment.

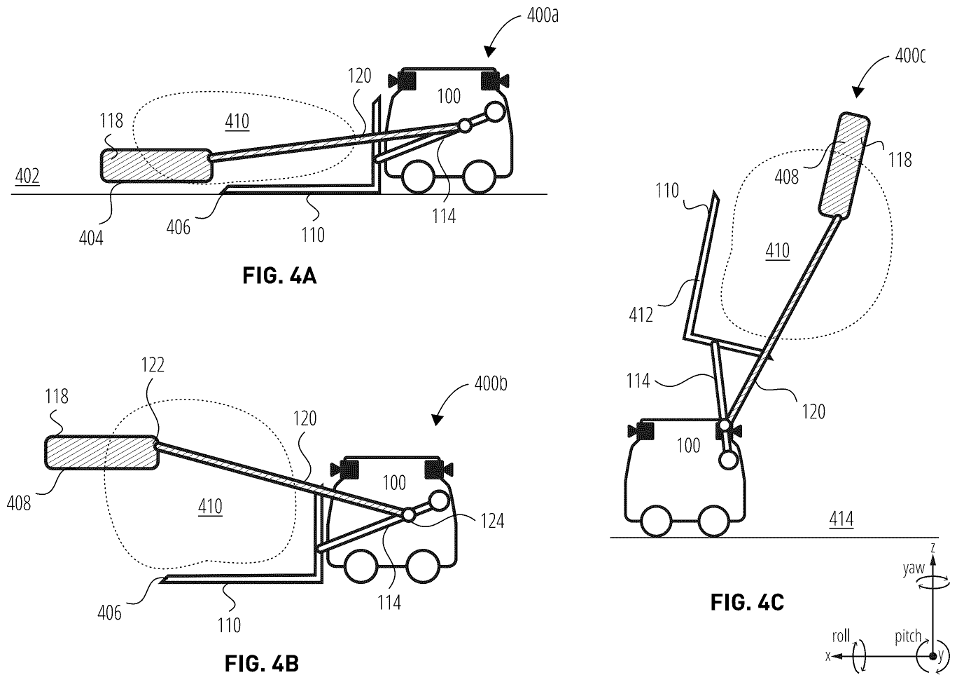

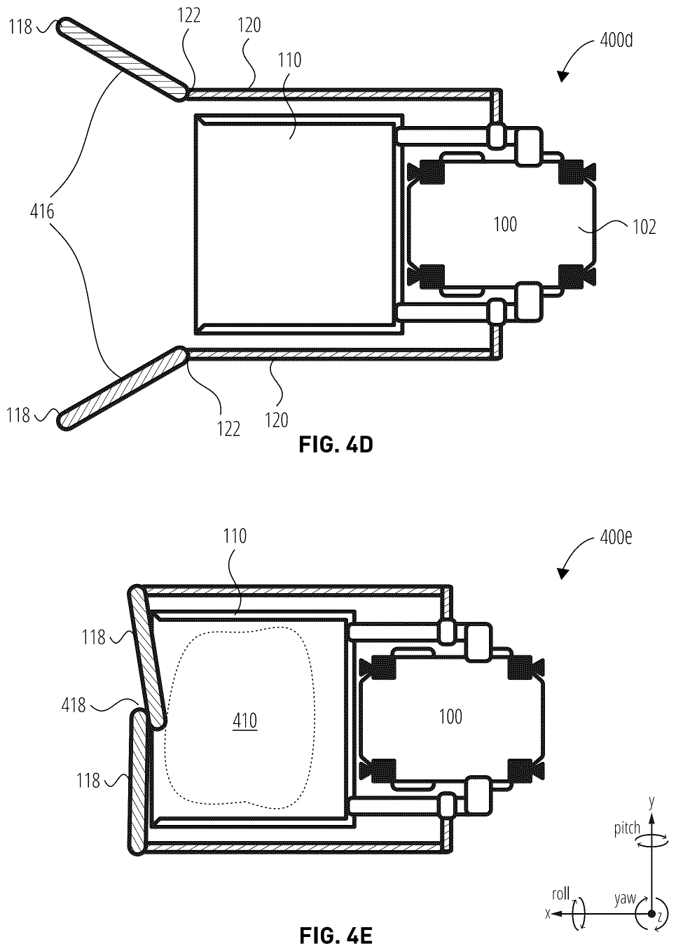

FIG. 4A illustrates a lowered scoop position and lowered pusher position 400a for the tidying robot 100 in accordance with one embodiment.

FIG. 4B illustrates a lowered scoop position and raised pusher position 400b for the tidying robot 100 in accordance with one embodiment.

FIG. 4C illustrates a raised scoop position and raised pusher position 400c for the tidying robot 100 in accordance with one embodiment.

FIG. 4D illustrates a tidying robot 100 with pusher pads extended 400d in accordance with one embodiment.

FIG. 4E illustrates a tidying robot 100 with pusher pads retracted 400e in accordance with one embodiment.

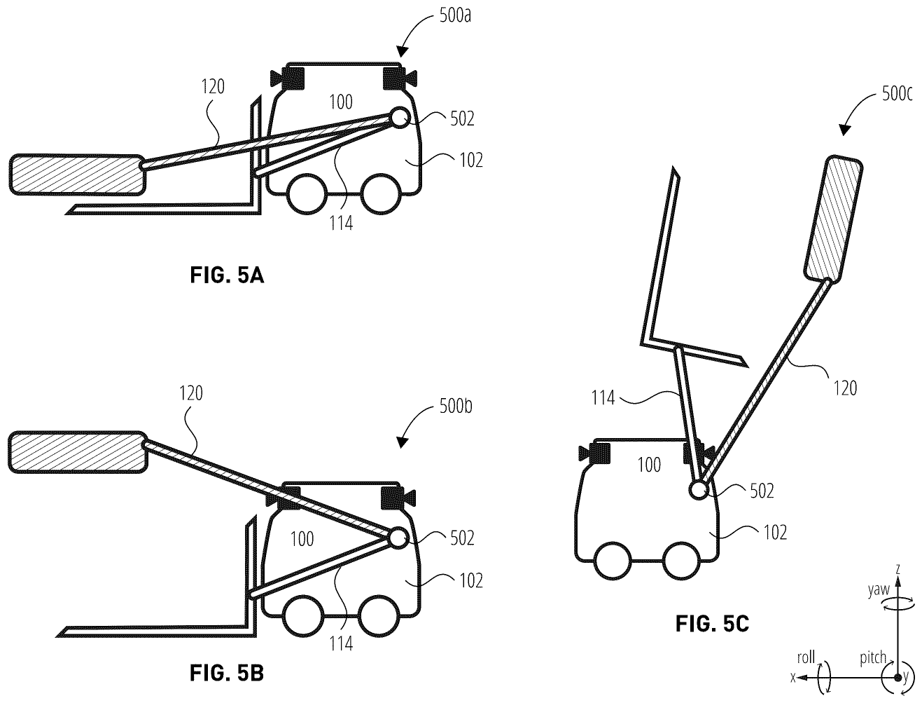

FIG. 5A illustrates a lowered scoop position and lowered pusher position 500a for the tidying robot 100 in accordance with one embodiment.

FIG. 5B illustrates a lowered scoop position and raised pusher position 500b for the tidying robot 100 in accordance with one embodiment.

FIG. 5C illustrates a raised scoop position and raised pusher position 500c for the tidying robot 100 in accordance with one embodiment.

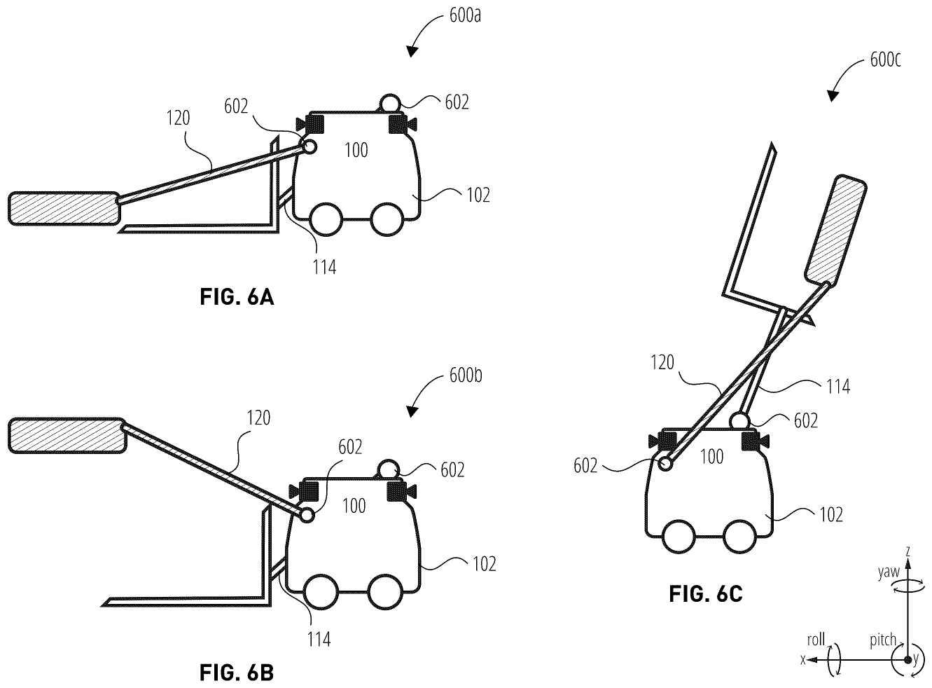

FIG. 6A illustrates a lowered scoop position and lowered pusher position 600a for the tidying robot 100 in accordance with one embodiment.

FIG. 6B illustrates a lowered scoop position and raised pusher position 600b for the tidying robot 100 in accordance with one embodiment.

FIG. 6C illustrates a raised scoop position and raised pusher position 600c for the tidying robot 100 in accordance with one embodiment.

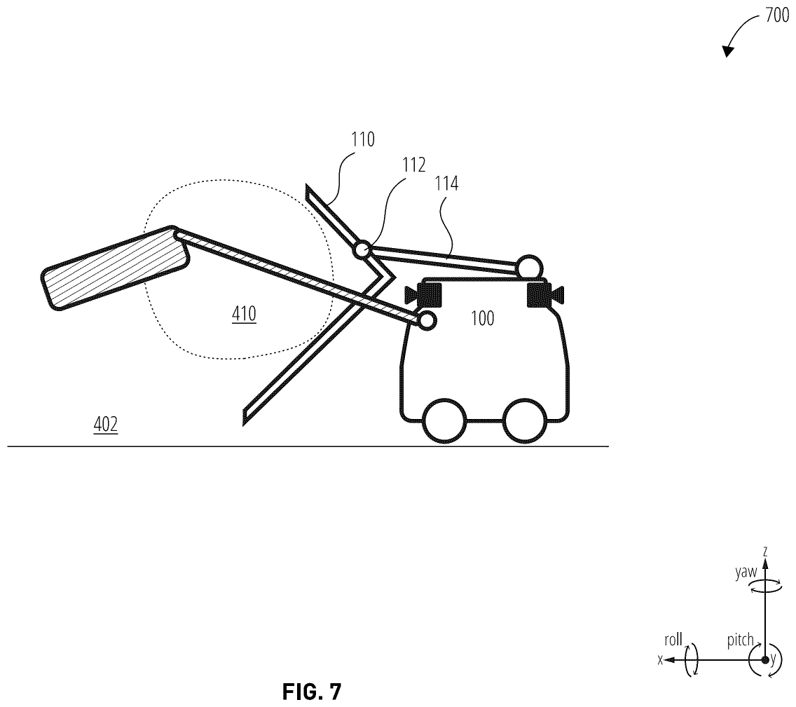

FIG. 7 illustrates a front dump action 800 for the tidying robot 100 in accordance with one embodiment.

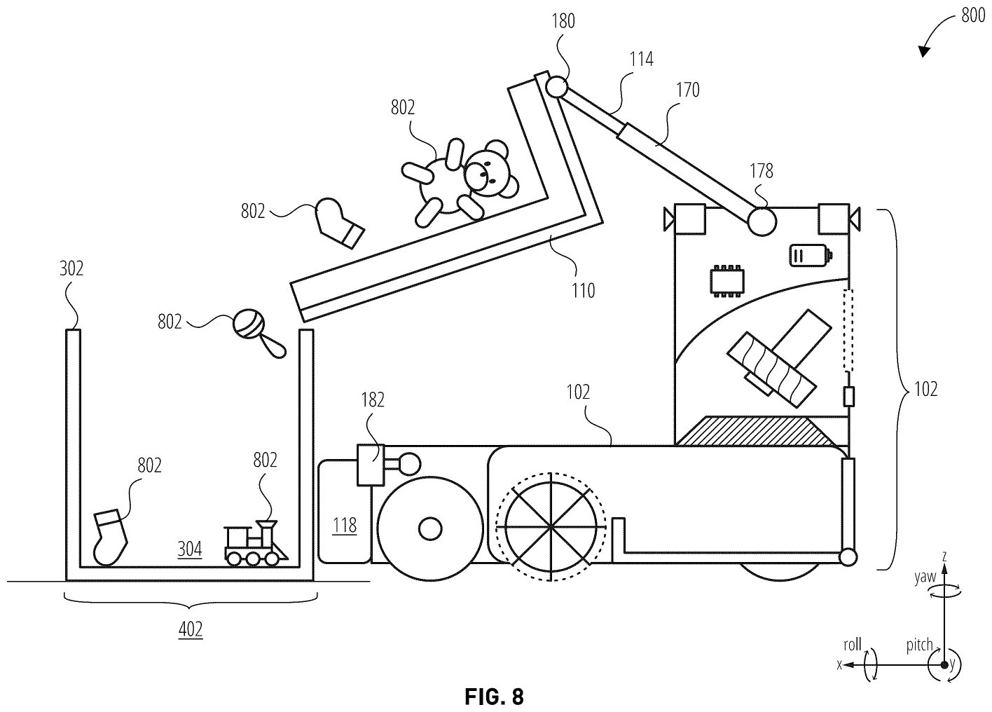

FIG. 8 illustrates a tidying robot 100 performing a front dump in accordance with one embodiment.

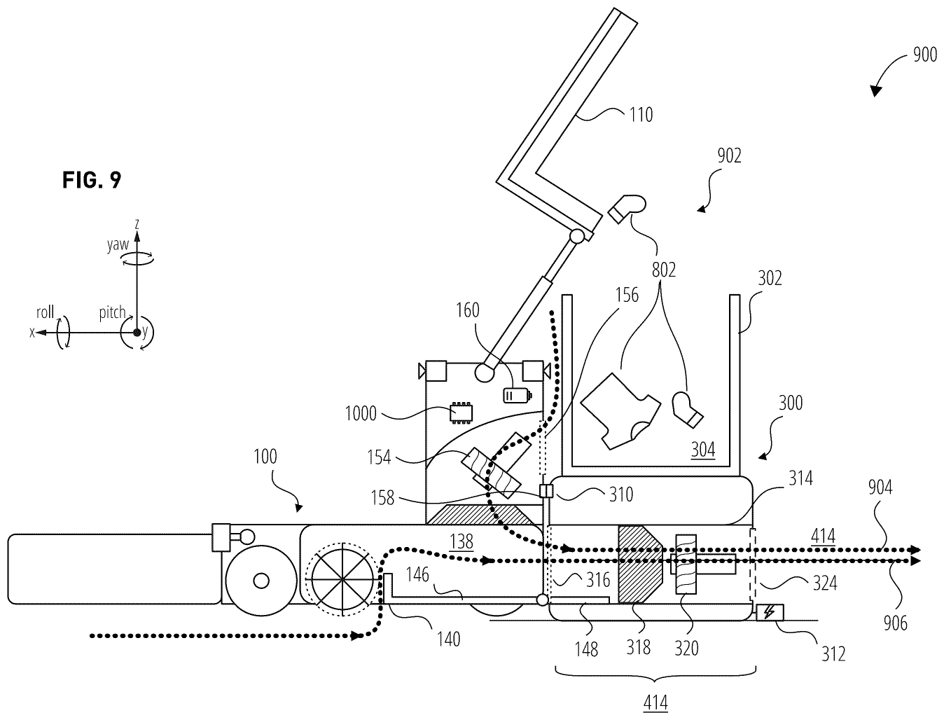

FIG. 9 illustrates a tidying robotic system interaction 900 in accordance with one embodiment.

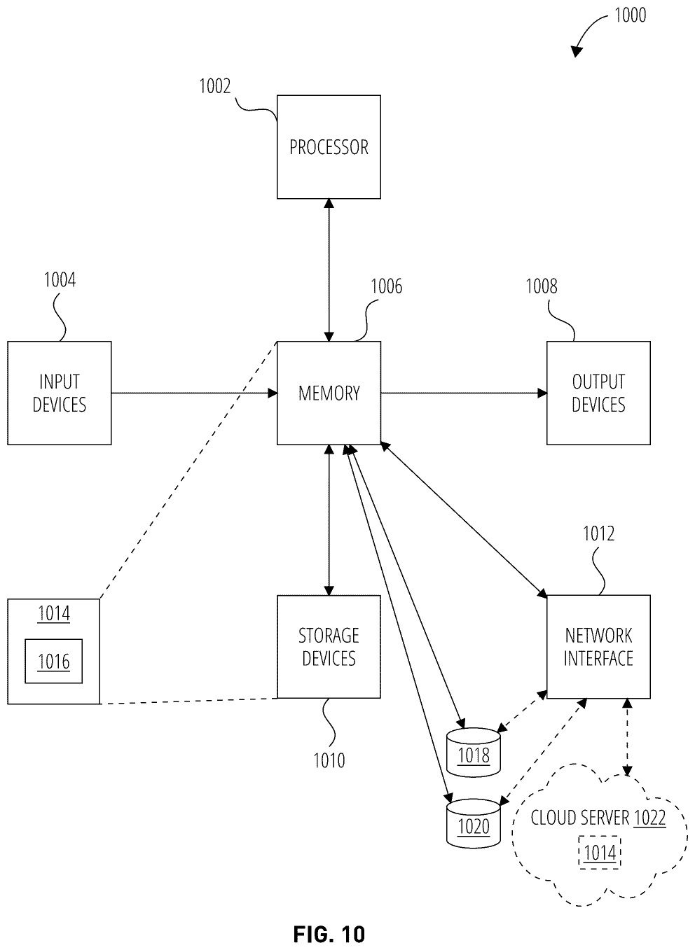

FIG. 10 illustrates an embodiment of a robotic control system 1000 to implement components and process steps of the system described herein.

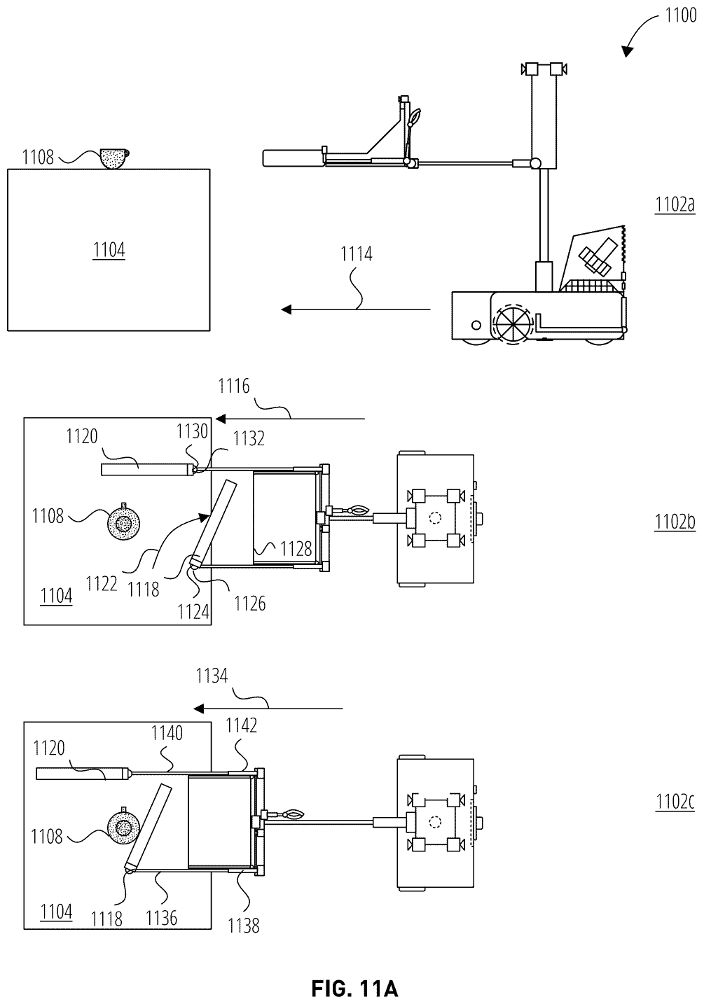

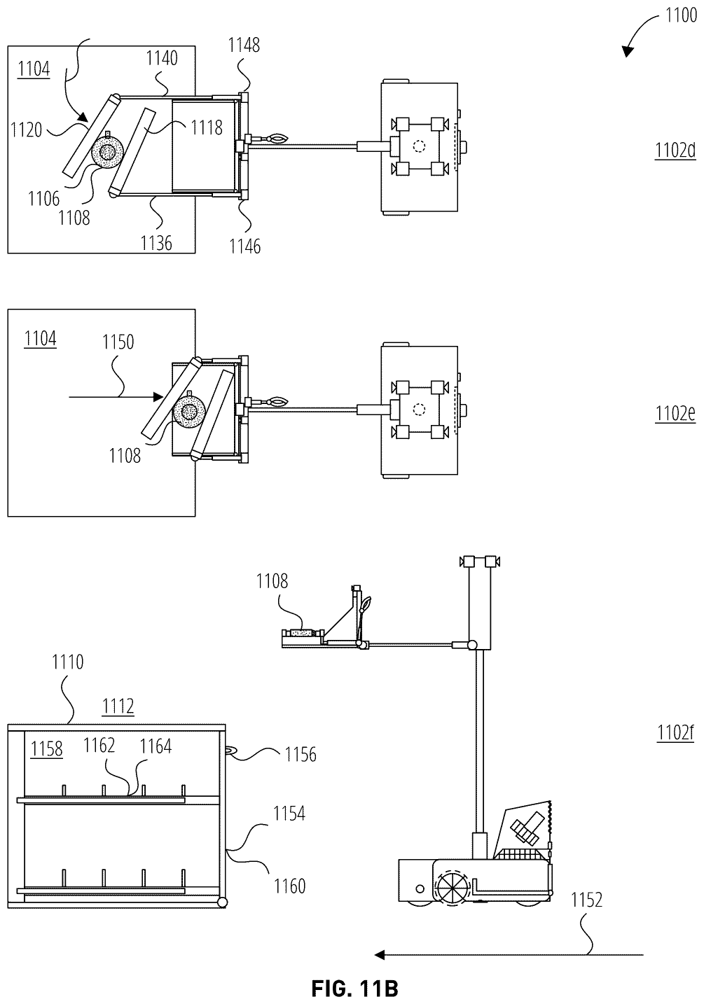

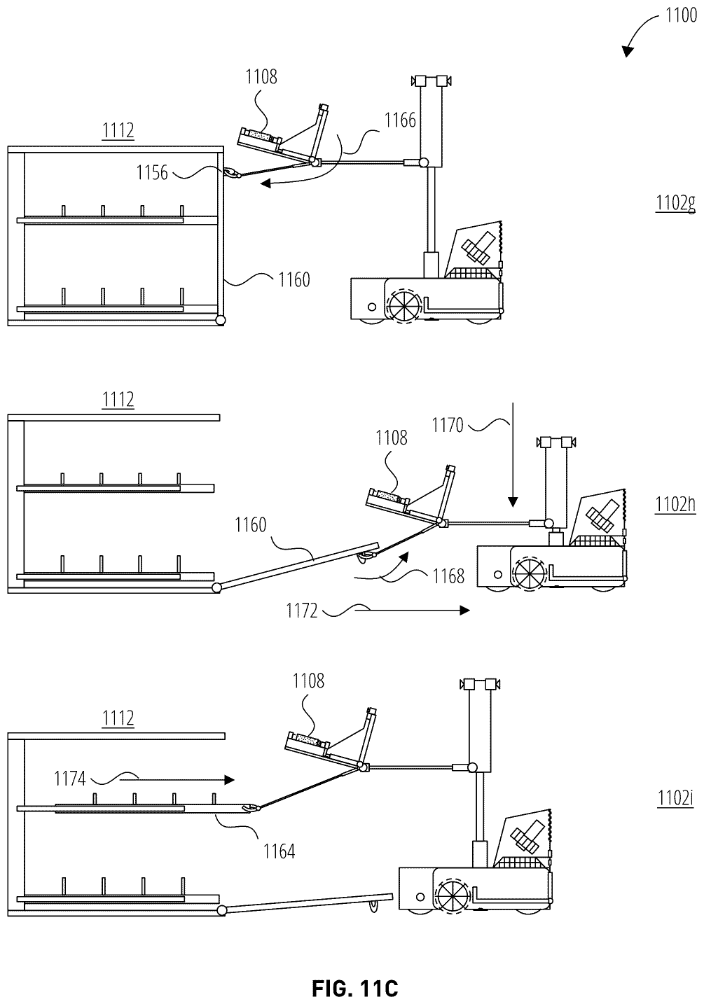

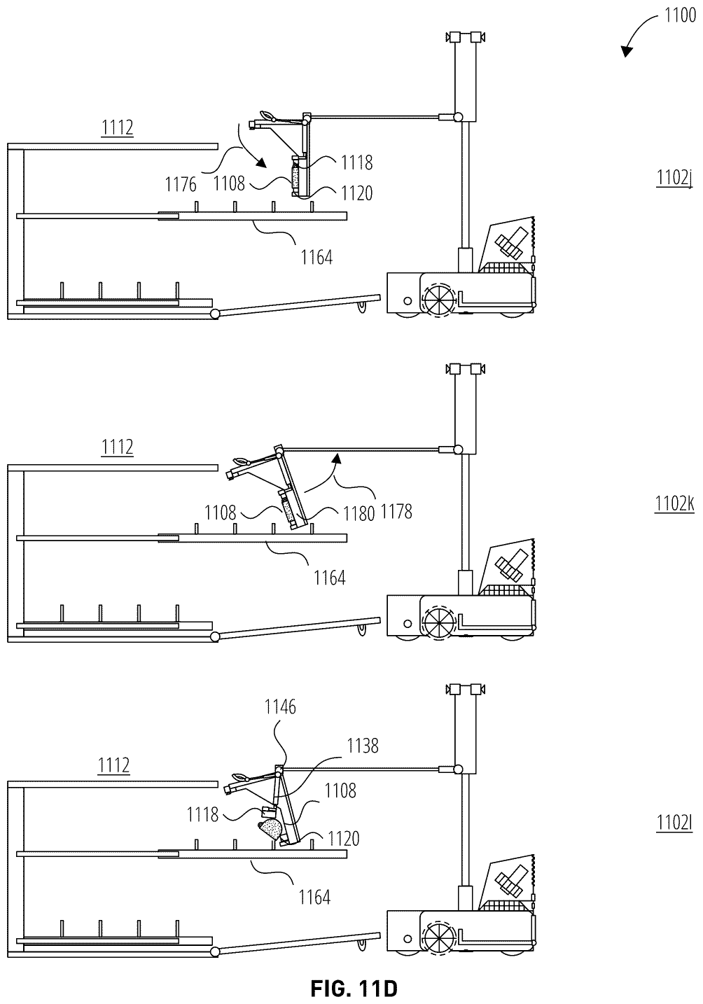

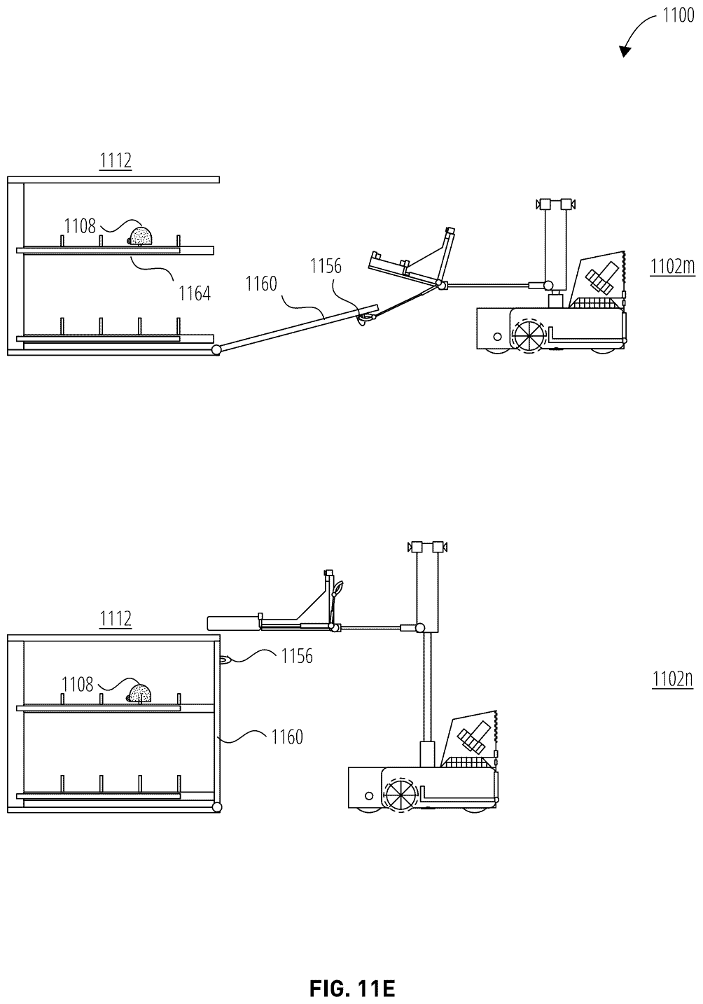

FIG. 11A-FIG. 11E illustrate an item placement procedure 1100 in accordance with one embodiment.

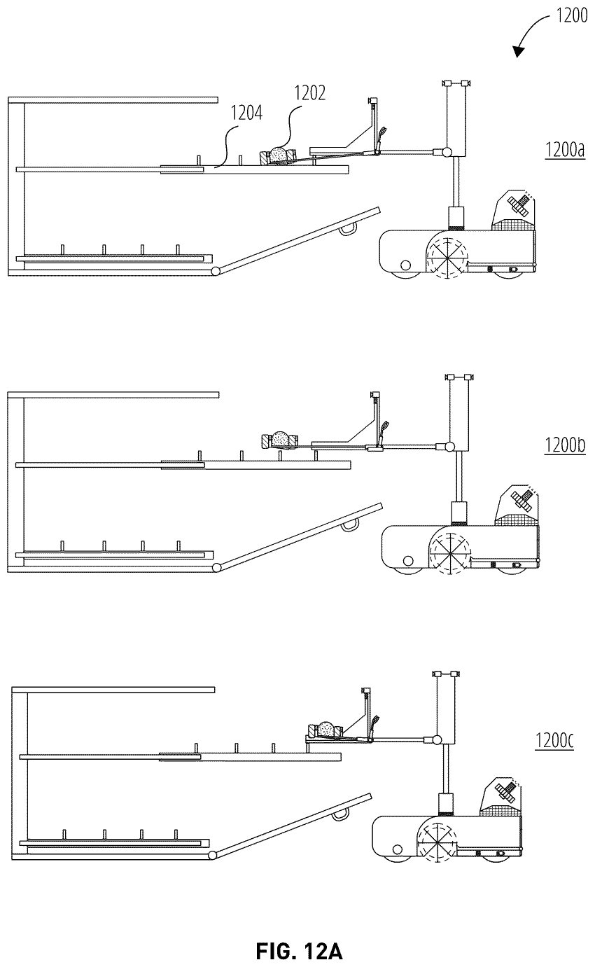

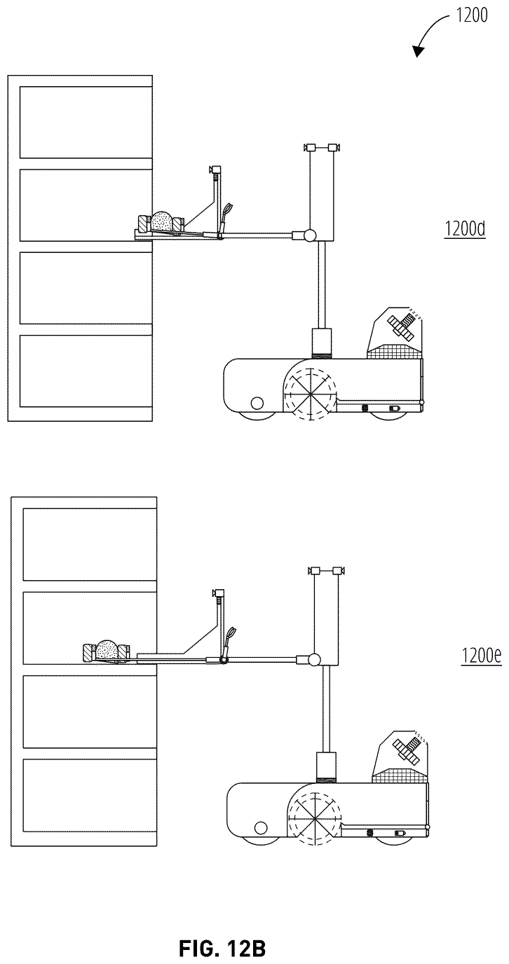

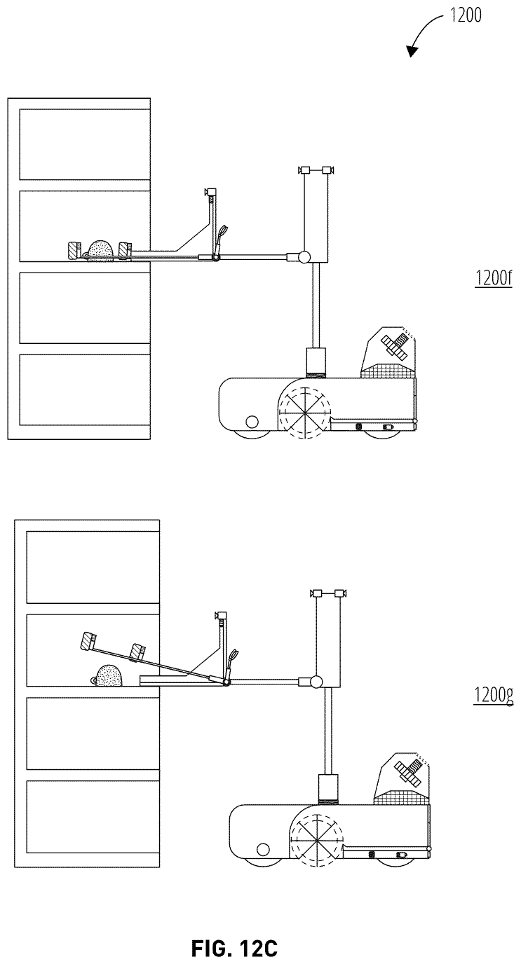

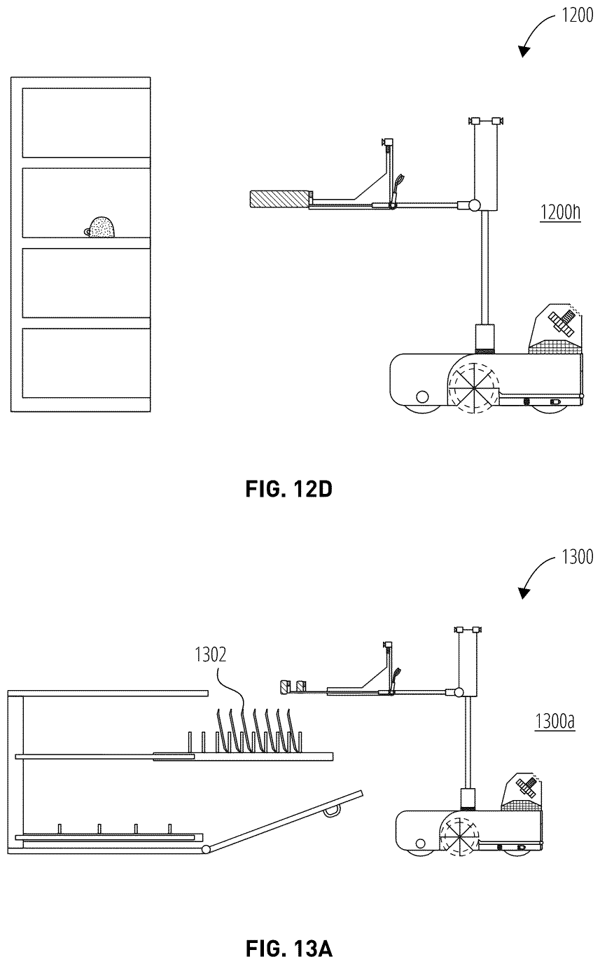

FIG. 12A-FIG. 12D illustrate an item removal procedure 1200 in accordance with one embodiment.

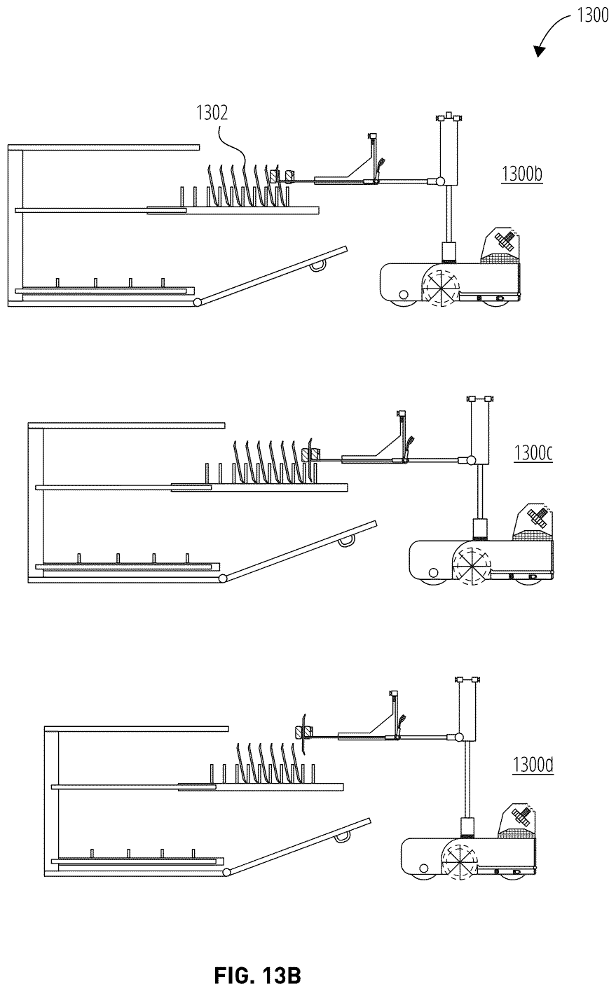

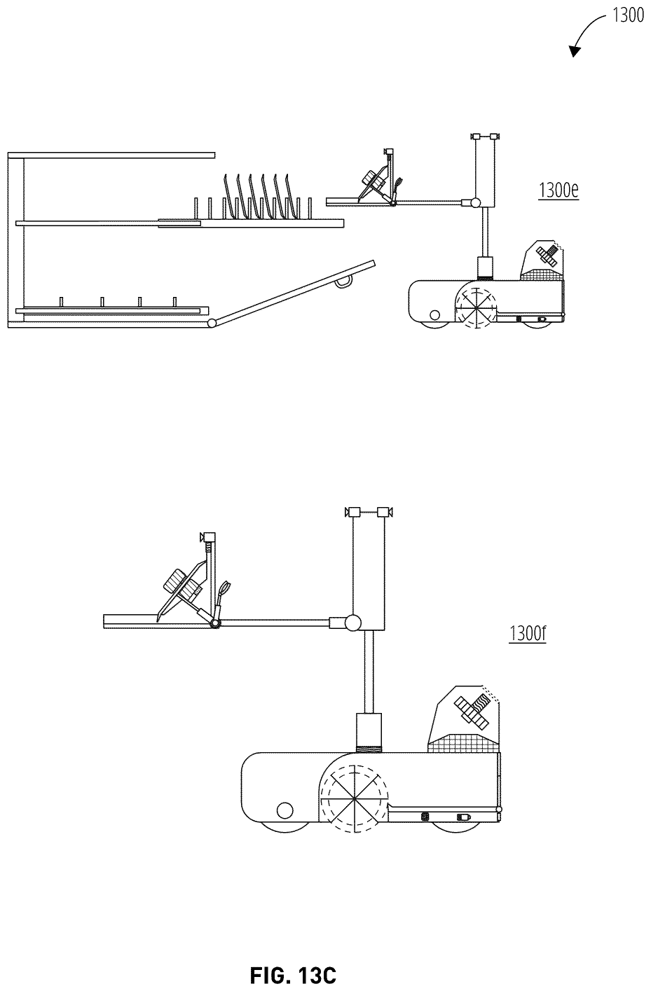

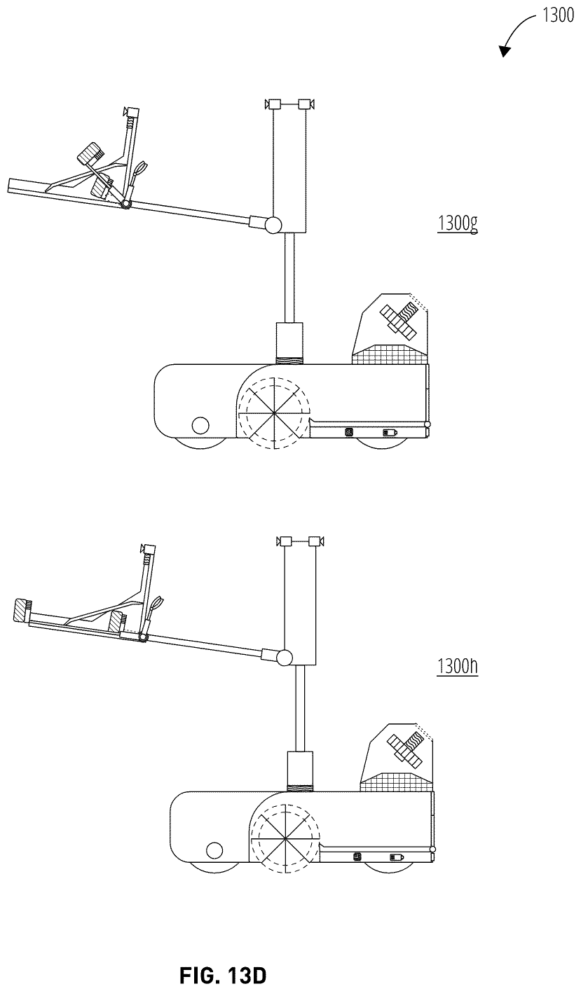

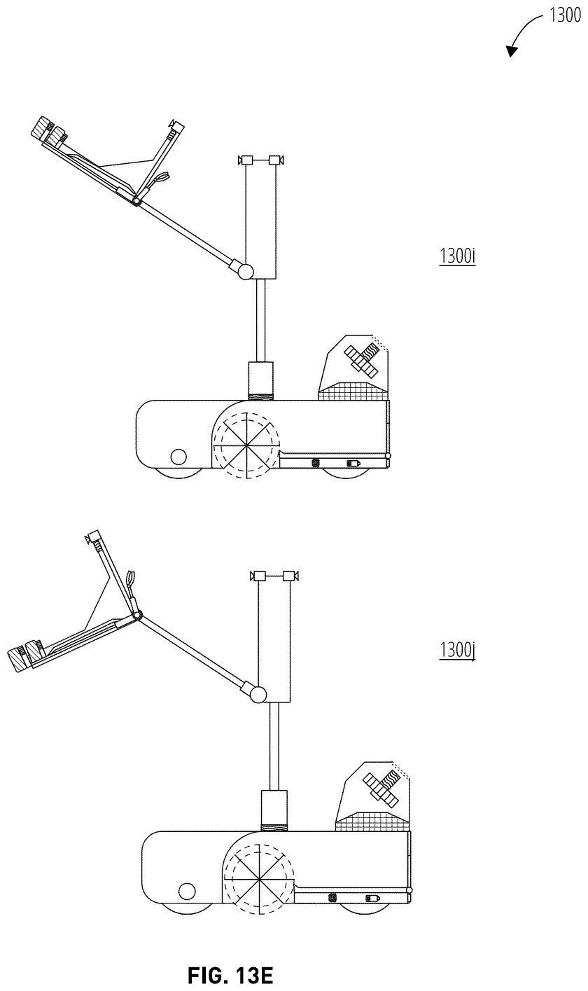

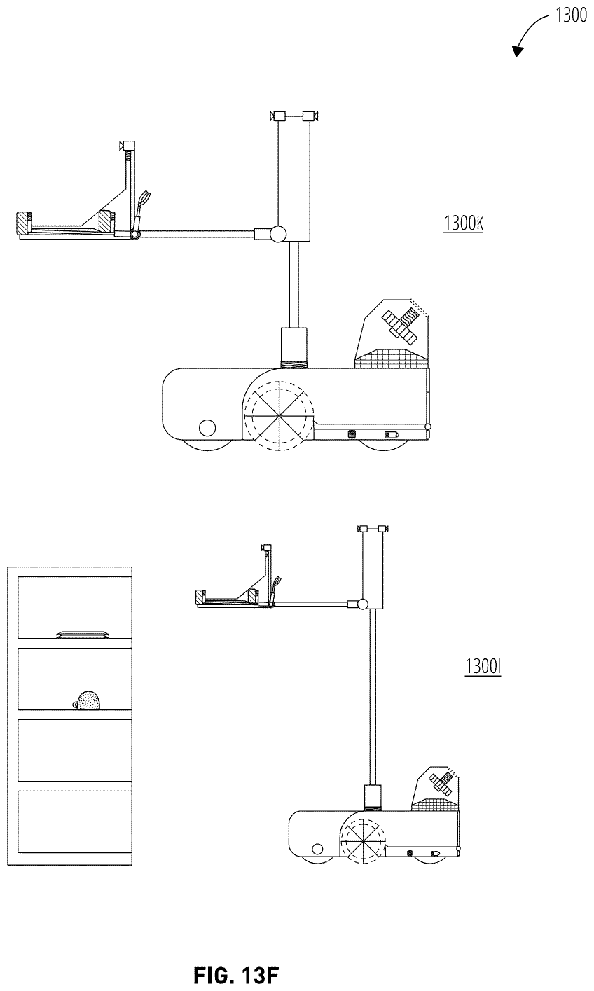

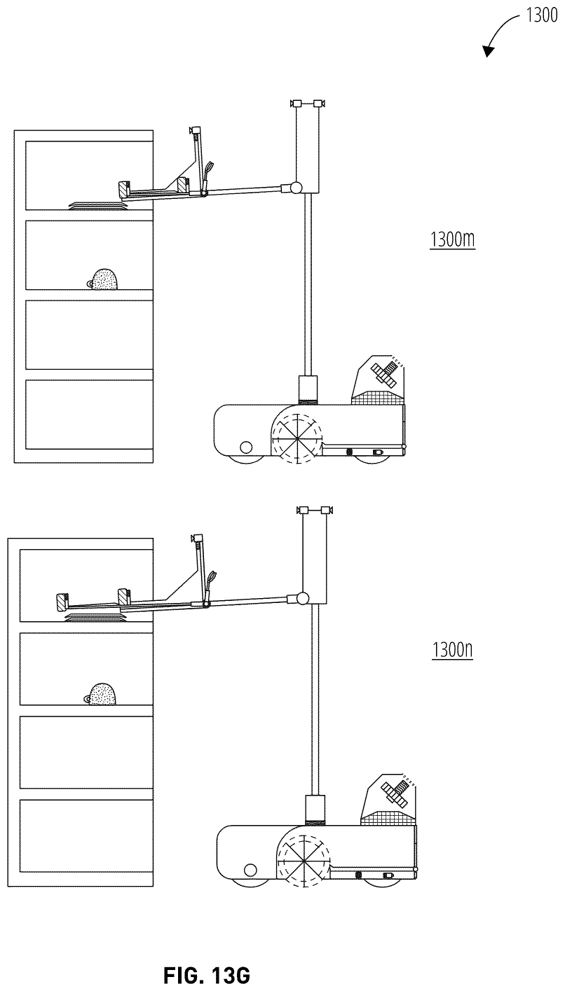

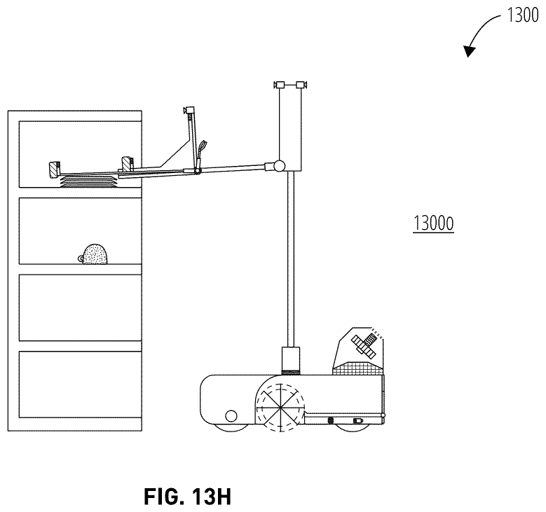

FIG. 13A-FIG. 13H illustrate an item removal procedure 1300 in accordance with one embodiment.

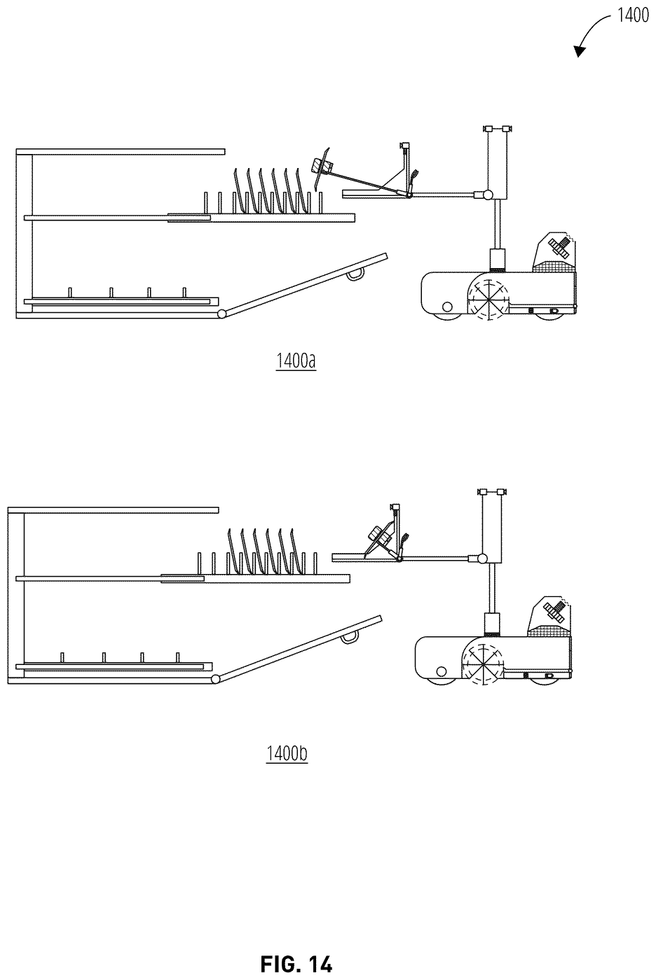

FIG. 14 illustrates an item removal procedure 1400 in accordance with one embodiment.

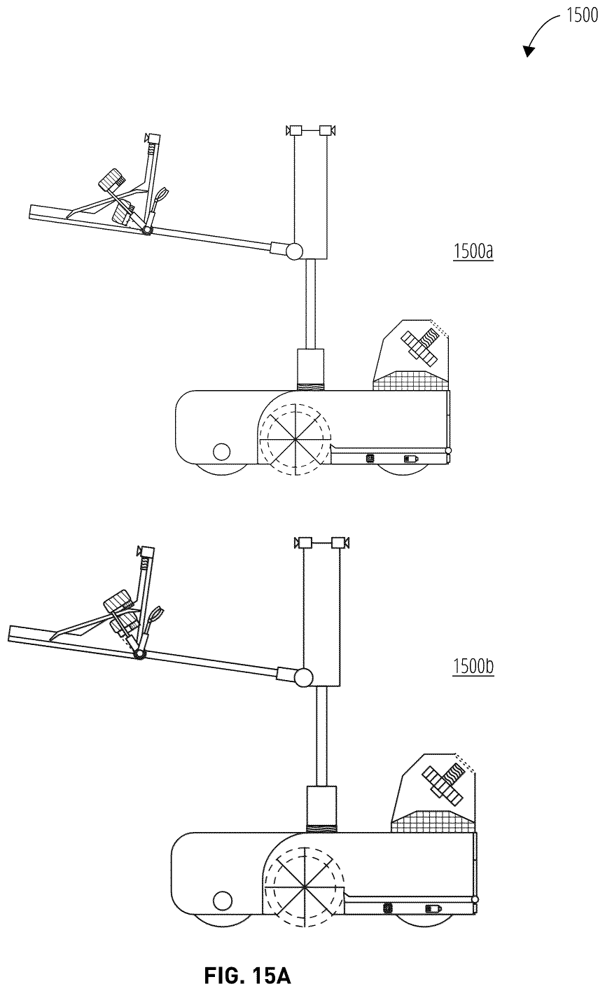

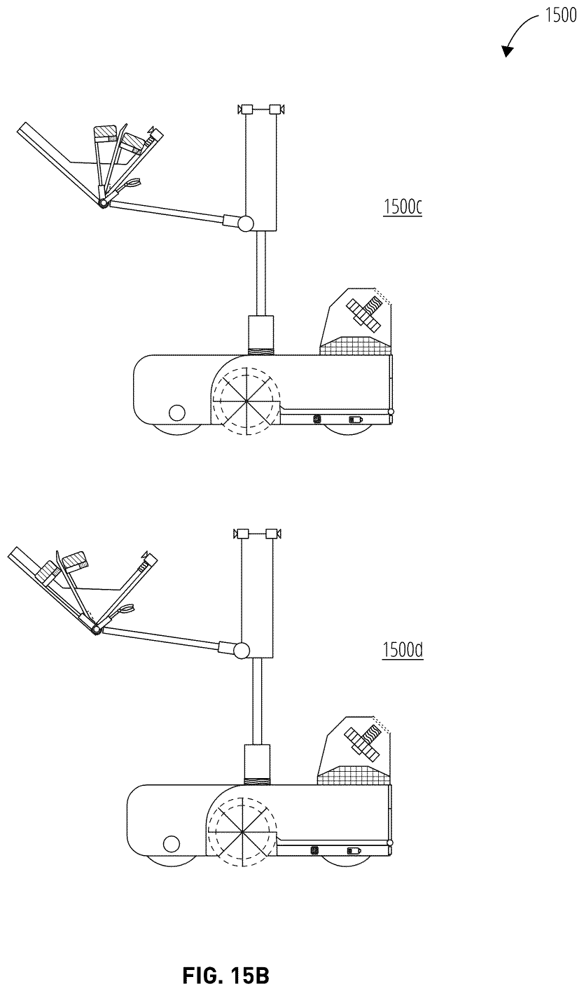

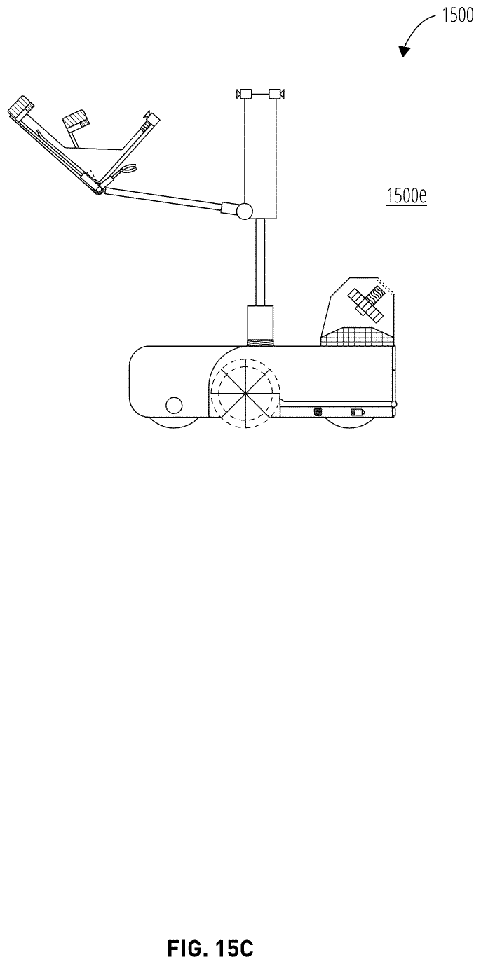

FIG. 15A-FIG. 15C illustrate an item flipping procedure 1500 in accordance with one embodiment.

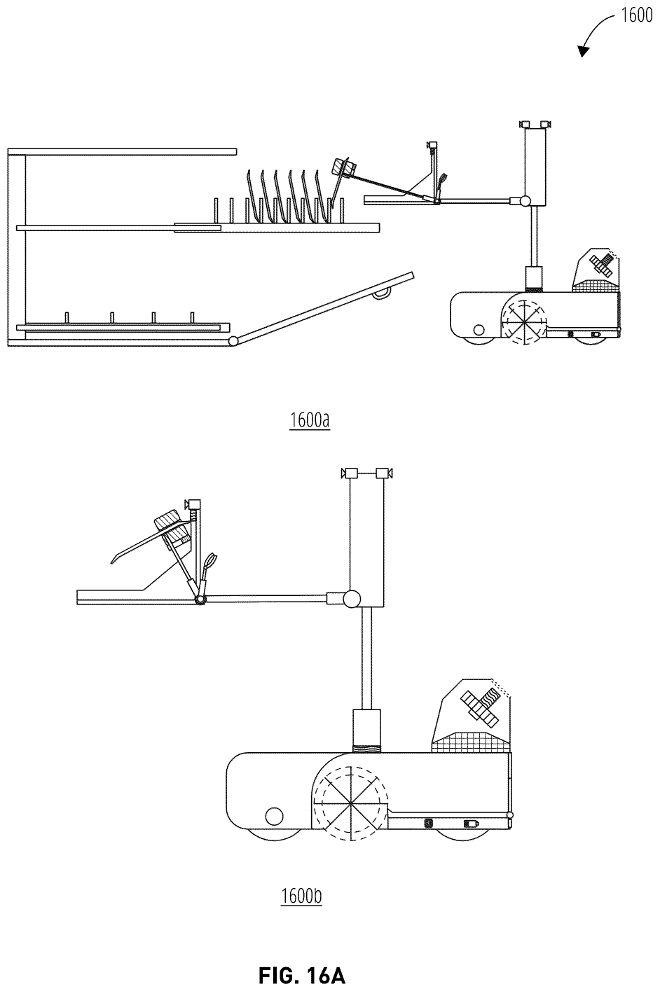

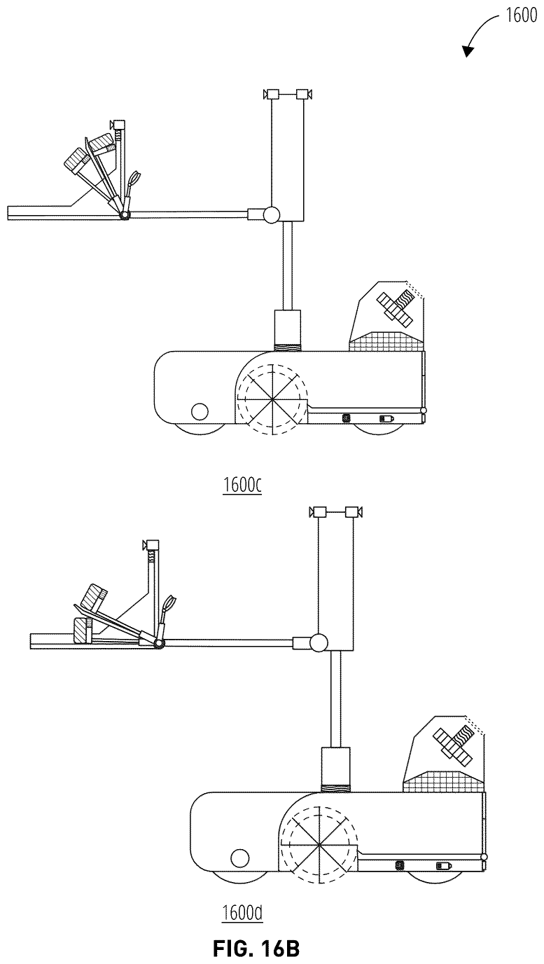

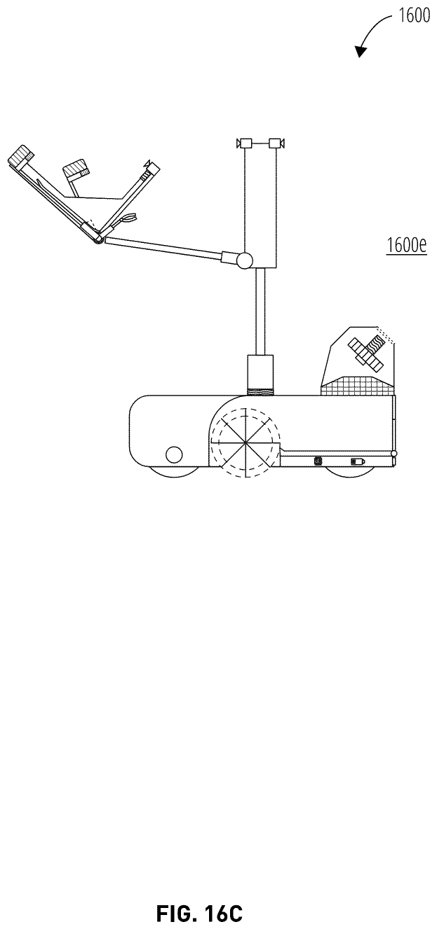

FIG. 16A-FIG. 16C illustrate an item flipping procedure 1600 in accordance with one embodiment.

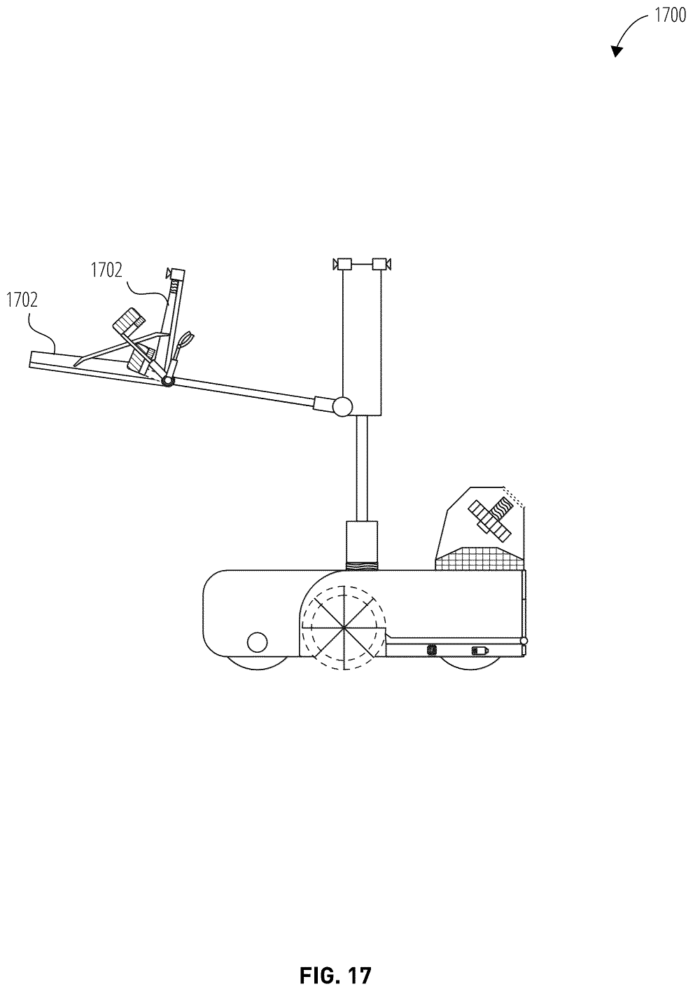

FIG. 17 illustrates scoop walls 1700 in accordance with one embodiment.

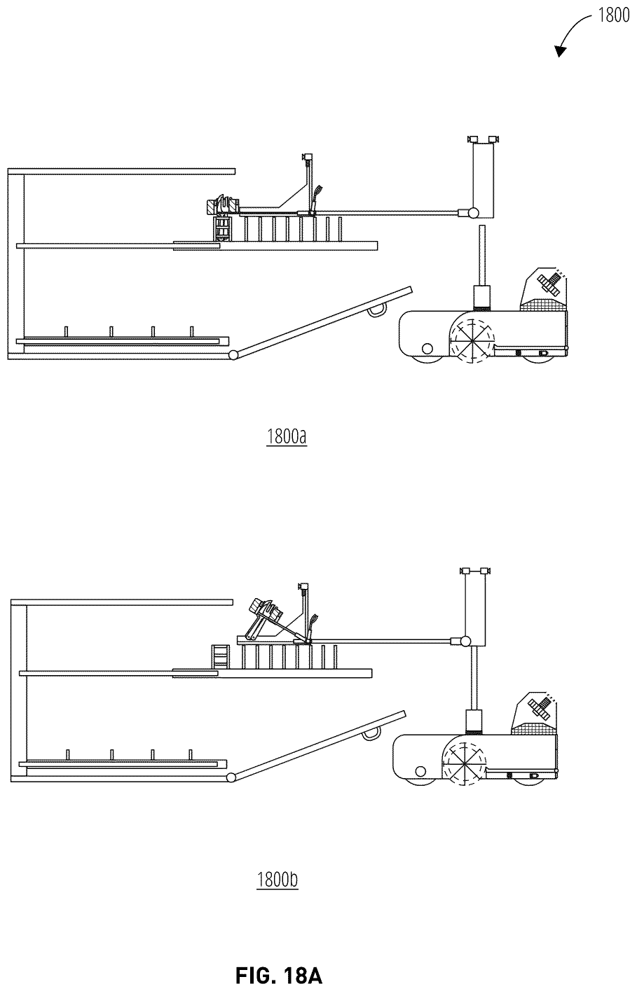

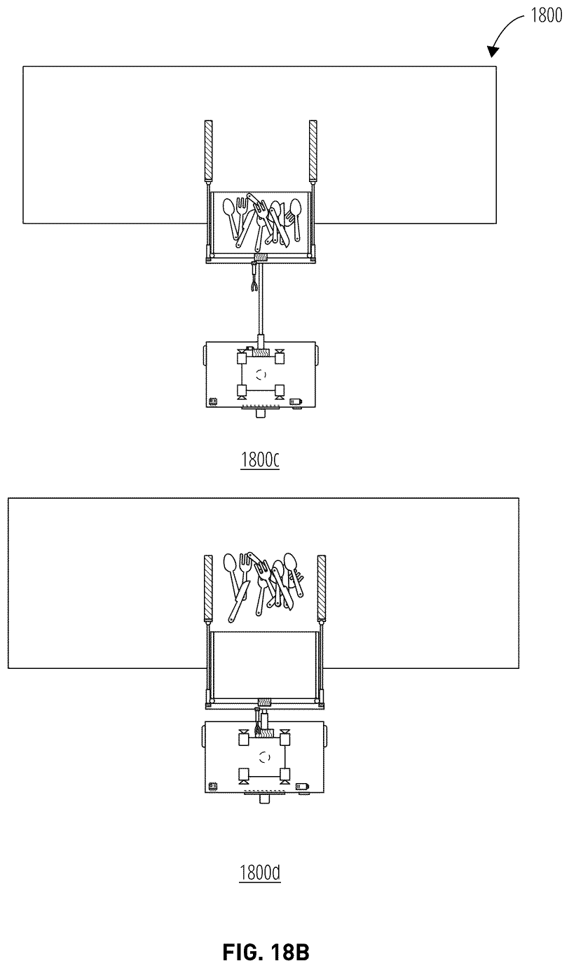

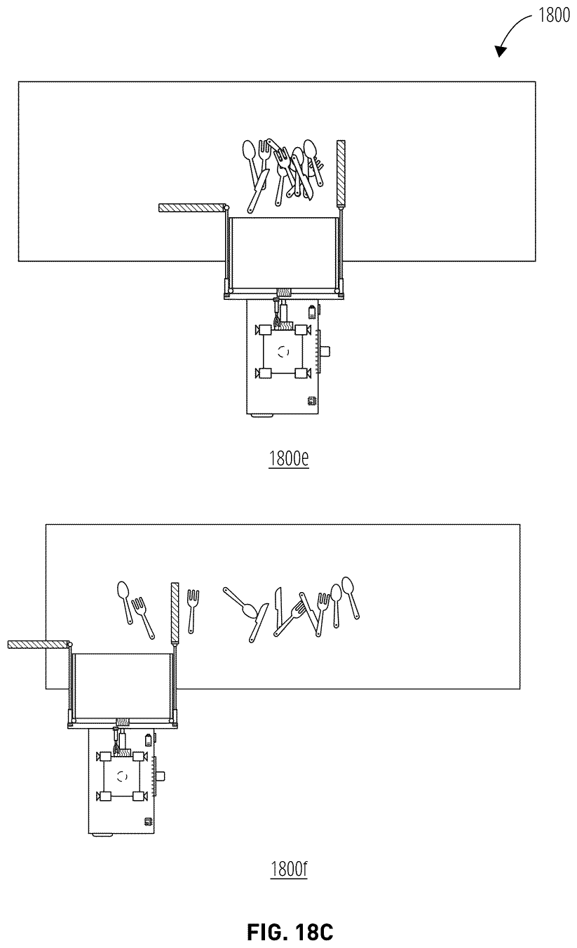

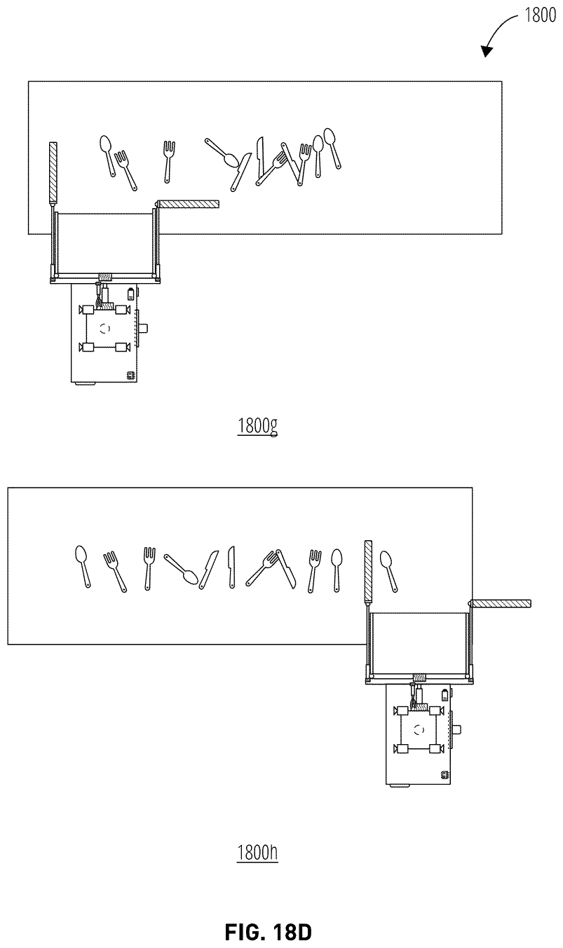

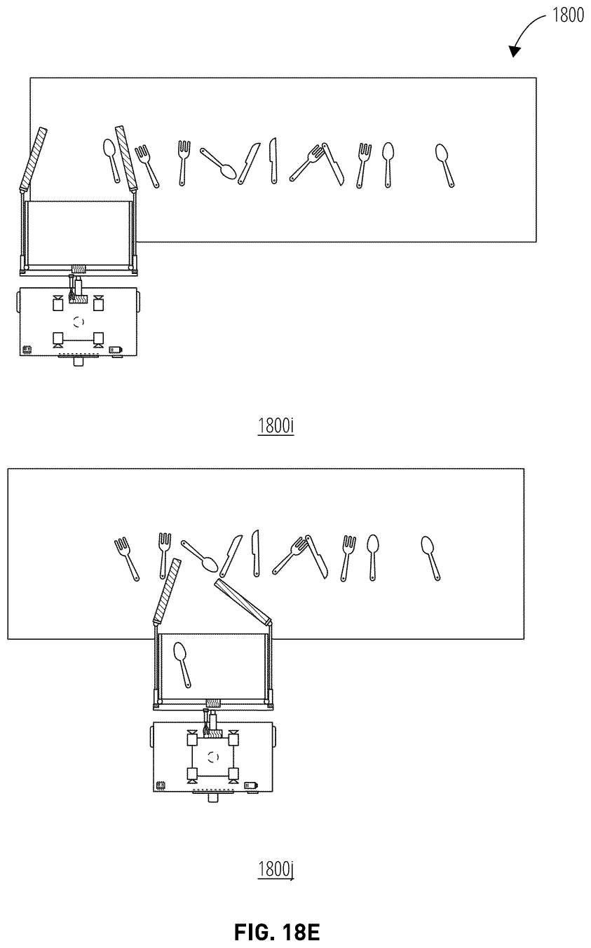

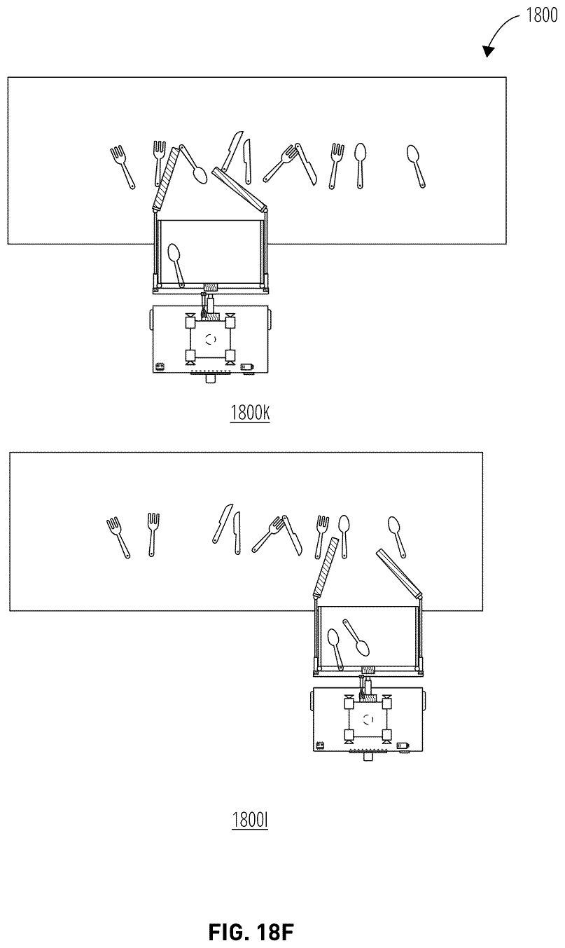

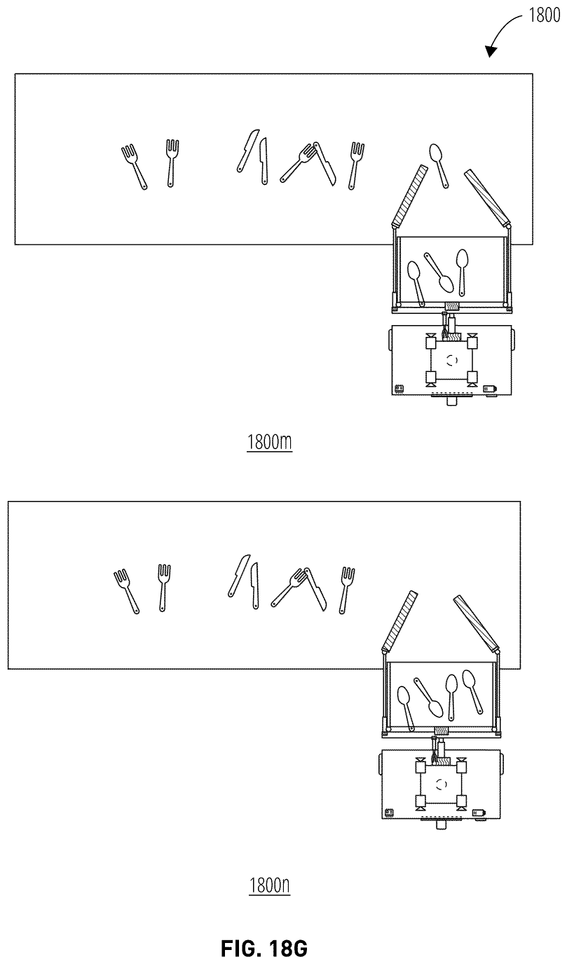

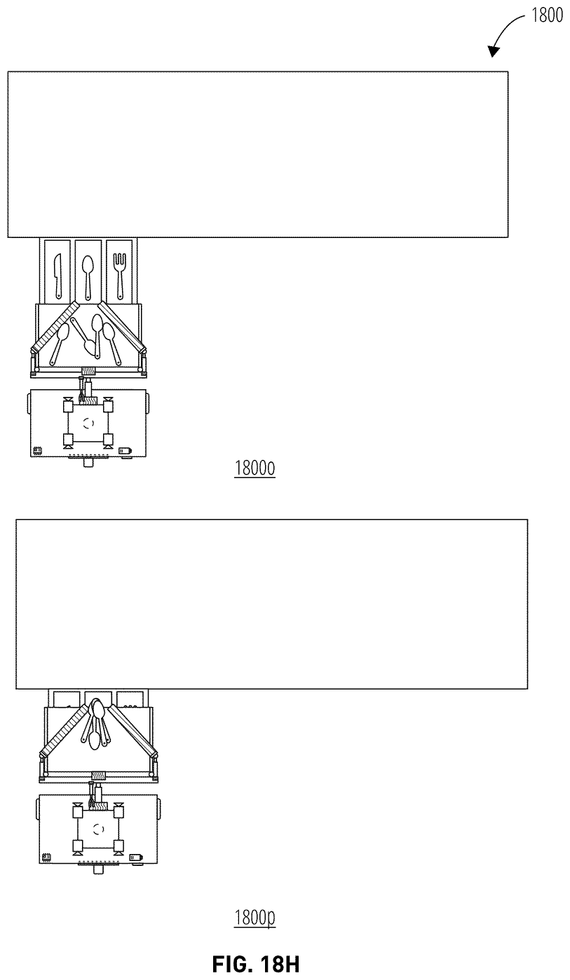

FIG. 18A-FIG. 18I illustrate a cutlery removal and sorting procedure 1800 in accordance with one embodiment.

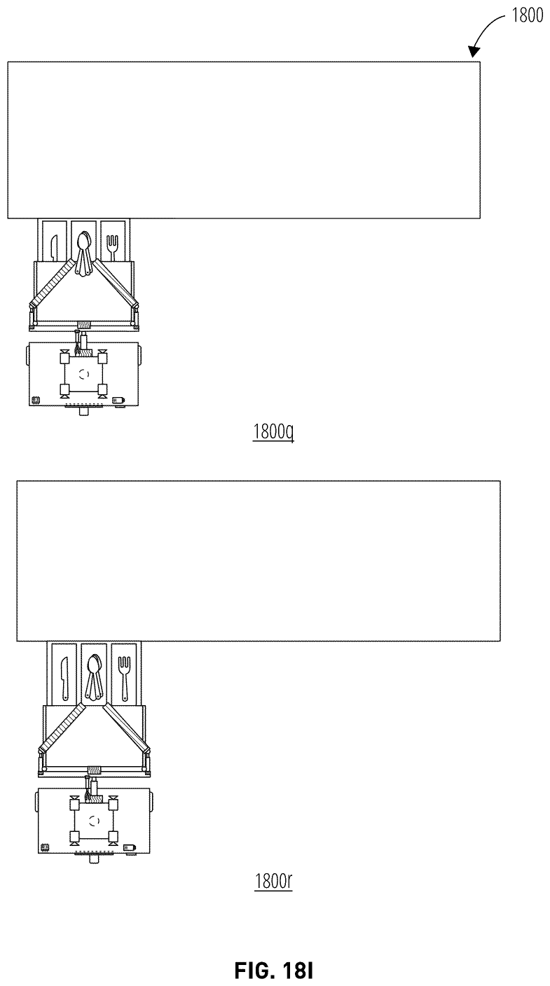

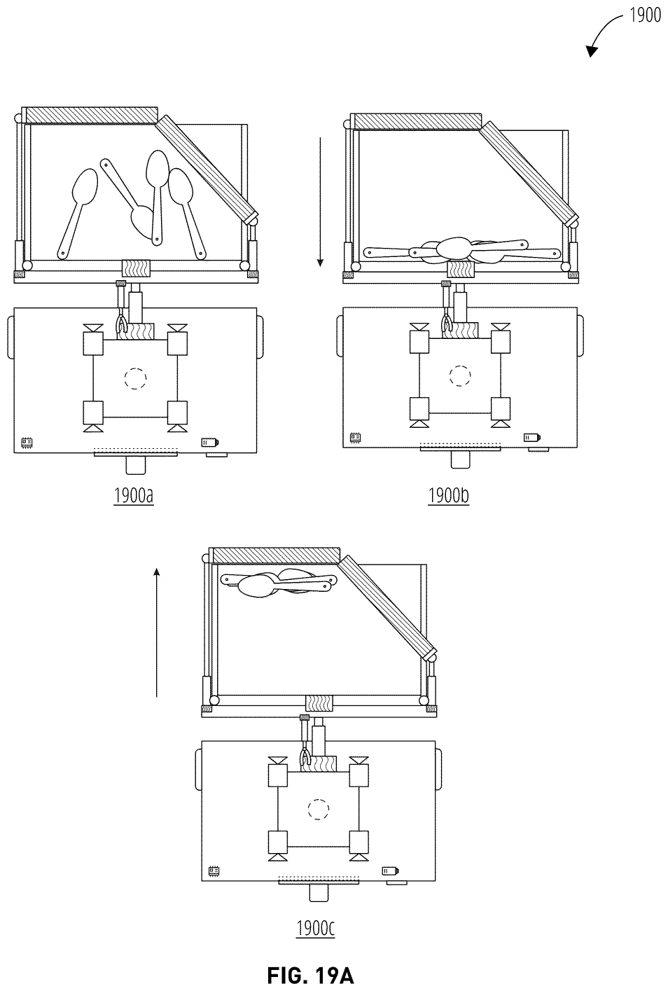

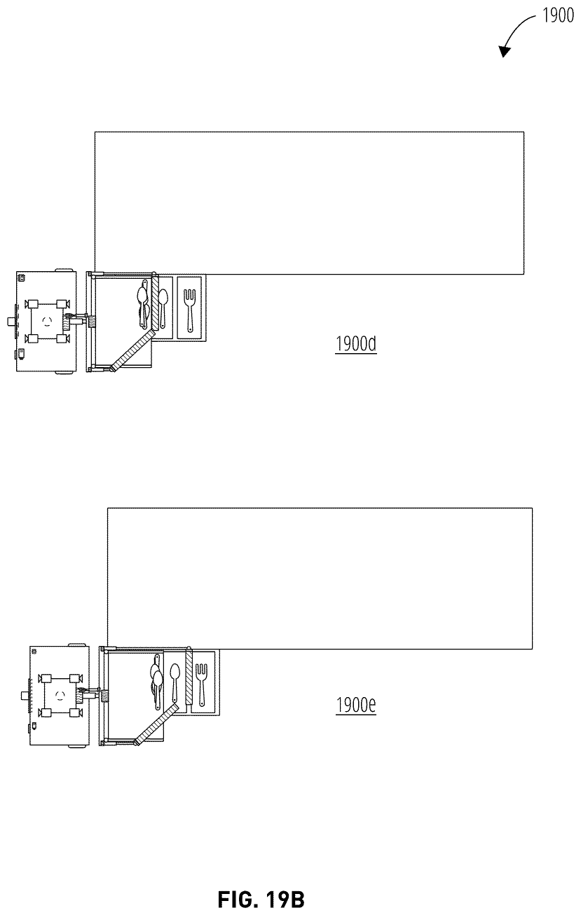

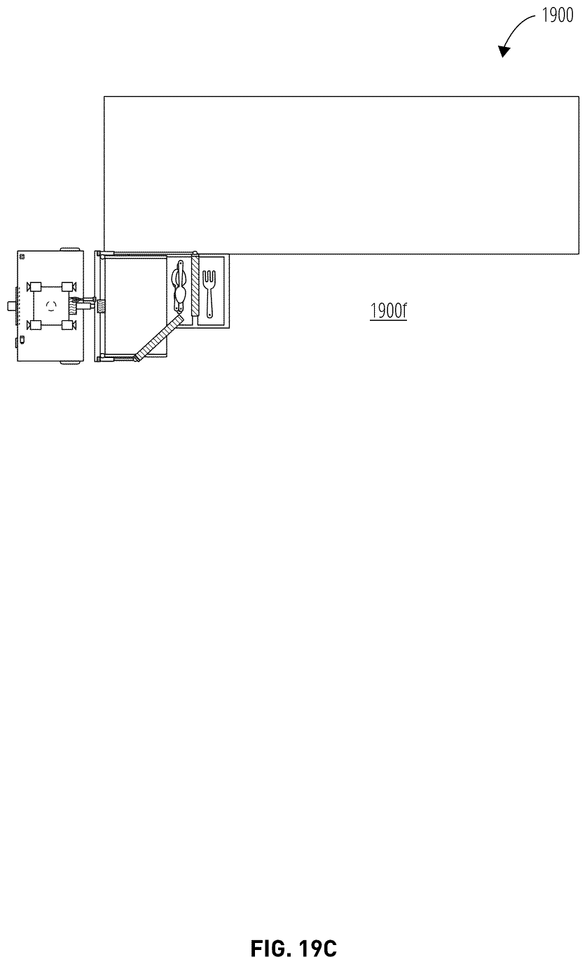

FIG. 19A-FIG. 19C illustrate a cutlery sorting procedure 1900 in accordance with one embodiment.

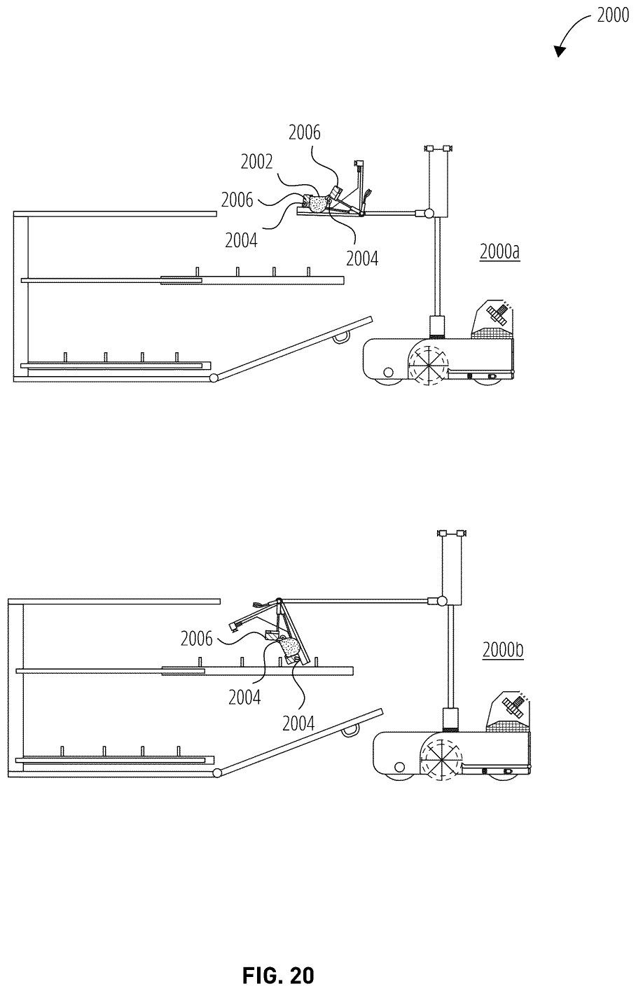

FIG. 20 illustrates an item loading procedure 2000 in accordance with one embodiment.

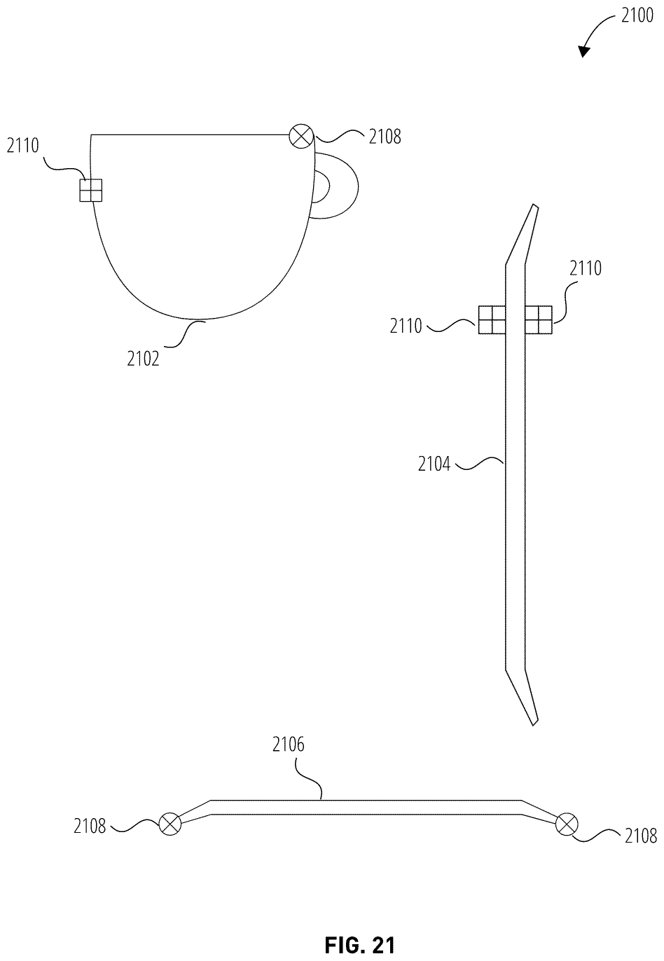

FIG. 21 illustrates a keypoint identification 2100 in accordance with one embodiment.

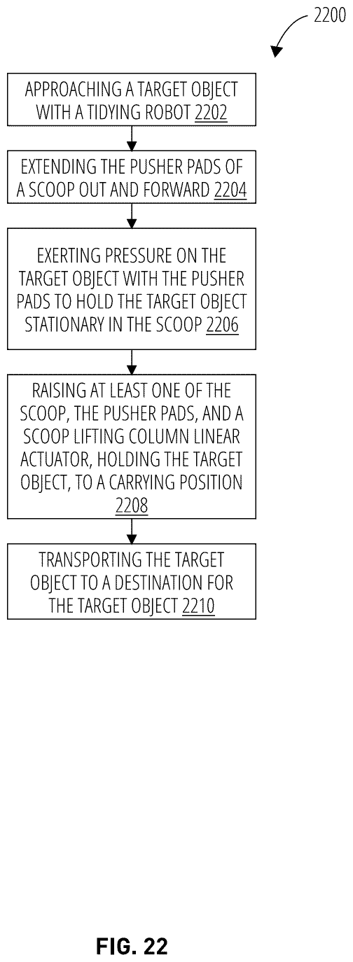

FIG. 22 illustrates a method 2200 in accordance with one embodiment.

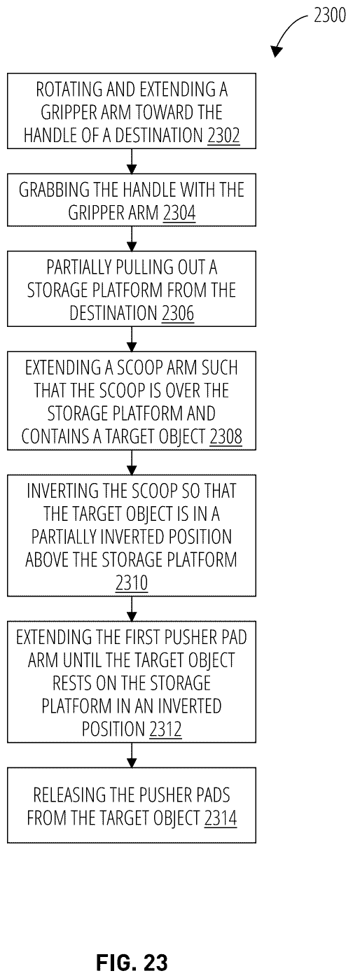

FIG. 23 illustrates a method 2300 in accordance with one embodiment.

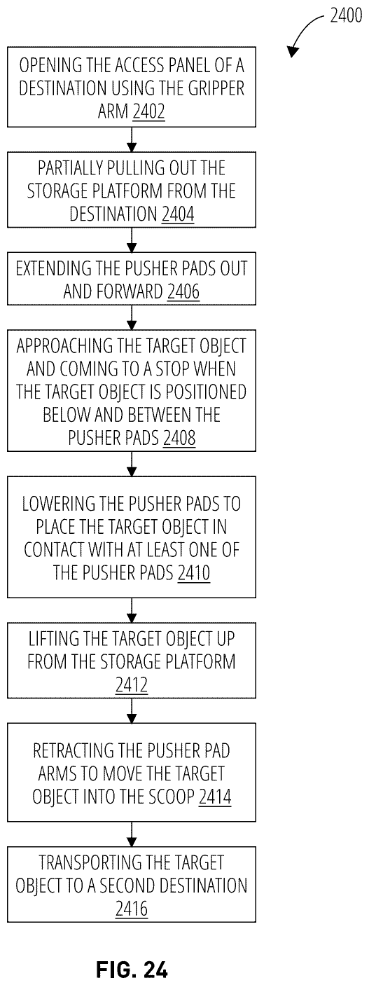

FIG. 24 illustrates a method 2400 in accordance with one embodiment.

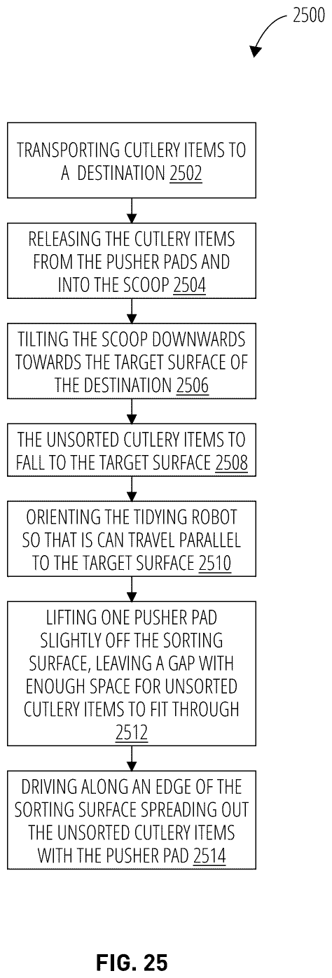

FIG. 25 illustrates a method 2500 in accordance with one embodiment.

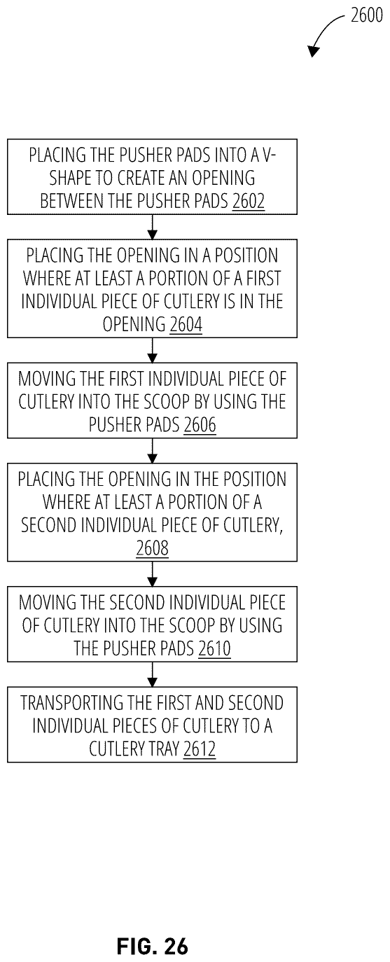

FIG. 26 illustrates a method 2600 in accordance with one embodiment.

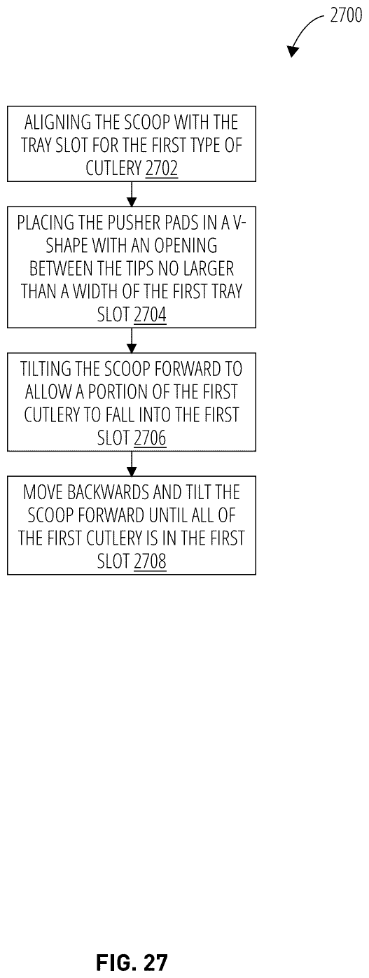

FIG. 27 illustrates a method 2700 in accordance with one embodiment.

### DETAILED DESCRIPTION

A general purpose tidying robot may load cups, plates, cutlery, cooking dishes, and other cookware and tableware into a dishwasher, and may unload the dishwasher and return the cookware and tableware to the appropriate cabinets once they are clean. The following shows the general purpose tidying robot interacting with a dishwasher to load and unload various items.

At a high level, the tidying robot may operate as follows to facilitate a smooth interaction with a dishwasher machine having dishwasher trays that slide in and out to accept items to be washed and dried. When loading the dishwasher the robot should attempt to leave sufficient space between items to facilitate unloading after the wash cycle.

The tidying robot may unload items from the dishwasher rom front to back and left to right in order to minimize interference with the arms. For example, if it starts in the front-left corner then there will be empty space to the left and in front, allowing the pusher pads to more easily grab that corner item first. Putting away that item then makes room to pick up the next item. The tidying robot may move its pusher pads approximately into position immediately above the target item being picked up and then using the primary vertical linear actuator to move the pusher pads vertically down to encapsulate the item. This might be needed in a situation where you have, for example, several plates arranged next to each other. In some cases, multiple thin/narrow objects, such as cutlery, may be picked up together with the pusher pads.

FIG. 1A-FIG. 2B illustrate a tidying robot 100 in accordance with one embodiment. FIG. 1A shows a side view and FIG. 1B shows a top view. The tidying robot 100 may comprise a chassis 102, a mobility system 104, a sensing system 106, a capture and containment system 108, and a robotic control system 1000. The capture and containment system 108 may further comprise a scoop 110, a scoop pivot point 112, a scoop arm 114, a scoop arm pivot point 116, two pusher pads 118 with pad pivot points 122, two pusher pad arms 120 with pad arm pivot points 124, an actuated gripper 126, a gripper arm 128 with a gripper pivot point 130, and a lifting column 132 to raise and lower the capture and containment system 108 to a desired height. In one embodiment, the gripper arm 128 may include features for gripping and/or gripping surfaces in lieu of or in addition to an actuated gripper 126.

The tidying robot 100 may further include a mop pad 134, and robot vacuum system 136. The robot vacuum system 136 may include a vacuum compartment 138, a vacuum compartment intake port 140, a cleaning airflow 142, a rotating brush 144, a dirt collector 146, a dirt release latch 148, a vacuum compartment filter 150, and a vacuum generating assembly 152 that includes a vacuum compartment fan 154, a vacuum compartment motor 166, and a vacuum compartment exhaust port 156. The tidying robot 100 may include a robot charge connector 158, a battery 160, and number of motors, actuators, sensors, and mobility components as described in greater detail below, and a robotic control system 1000 providing actuation signals based on sensor signals and user inputs.

The chassis 102 may support and contain the other components of the tidying robot 100. The mobility system 104 may comprise wheels as indicated, as well as caterpillar tracks, conveyor belts, etc., as is well understood in the art. The mobility system 104 may further comprise motors, servos, or other sources of rotational or kinetic energy to impel the tidying robot 100 along its desired paths. Mobility system 104 components may be mounted on the chassis 102 for the purpose of moving the entire robot without impeding or inhibiting the range of motion needed by the capture and containment system 108. Elements of a sensing system 106, such as cameras, lidar sensors, or other components, may be mounted on the chassis 102 in positions giving the tidying robot 100 clear lines of sight around its environment in at least some configurations of the chassis 102, scoop 110, pusher pad 118, and pusher pad arm 120 with respect to each other.

The chassis 102 may house and protect all or portions of the robotic control system 1000, (portions of which may also be accessed via connection to a cloud server) comprising in some embodiments a processor, memory, and connections to the mobility system 104, sensing system 106, and capture and containment system 108. The chassis 102 may contain other electronic components such as batteries 160, wireless communications 206 devices, etc., as is well understood in the art of robotics. The robotic control system 1000 may function as described in greater detail with respect to FIG. 10. The mobility system 104 and or the robotic control system 1000 may incorporate motor controllers used to control the speed, direction, position, and smooth movement of the motors. Such controllers may also be used to detect force feedback and limit maximum current (provide overcurrent protection) to ensure safety and prevent damage.

The capture and containment system 108 may comprise a scoop 110 with an associated scoop motor 180 to rotate the scoop 110 into different positions at the scoop pivot point 112. The capture and containment system 108 may also include a scoop arm 114 with an associated scoop arm motor 178 to rotate the scoop arm 114 into different positions around the scoop arm pivot point 116, and a scoop arm linear actuator 170 to extend the scoop arm 114. Pusher pads 118 of the capture and containment system 108 may have pusher pad motors 182 to rotate them into different positions around the pad pivot points 122. Pusher pad arms 120 may be associated with pusher pad arm motors 184 that rotate them around pad arm pivot points 124, as well as pusher pad arm linear actuators 172 to extend and retract the pusher pad arms 120. The gripper arm 128 may include a gripper arm motor 186 to move the gripper arm 128 around a gripper pivot point 130, as well as a gripper arm linear actuator 174 to extend and retract the gripper arm 128. In this manner the gripper arm 128 may be able to move and position itself and/or the actuated gripper 126 to perform the tasks disclosed herein.

Points of connection shown herein between the scoop arms and pusher pad arms are exemplary positions and are not intended to limit the physical location of such points of connection. Such connections may be made in various locations as appropriate to the construction of the chassis and arms, and the applications of intended use. In some embodiments, the pusher pad arms 120 may attach to the scoop 110, as shown here. In other embodiments, the pusher pad arm 120 may attach to the chassis 102 as shown, for example, in FIG. 5A or FIG. 8. It will be well understood by one of ordinary skill in the art that the configurations illustrated may be designed to perform the basic motions described with respect to FIG. 4A-FIG. 9 and the processes illustrated elsewhere herein.

The geometry of the scoop 110 and the disposition of the pusher pads 118 and pusher pad arms 120 with respect to the scoop 110 may describe a containment area, illustrated more clearly in FIG. 4A-FIG. 4E, in which objects may be securely carried. Servos, direct current (DC) motors, or other actuators at the scoop arm pivot point 116, pad pivot points 122, and pad arm pivot points 124 may be used to adjust the disposition of the scoop 110, pusher pads 118, and pusher pad arms 120 between fully lowered scoop and grabber positions and raised scoop and grabber positions, as illustrated with respect to FIG. 4A-FIG. 4C.

In some embodiments, gripping surfaces may be configured on the sides of the pusher pads 118 facing inward toward objects to be lifted. These gripping surfaces may provide cushion, grit, elasticity, or some other feature that increases friction between the pusher pads 118 and objects to be captured and contained. In some embodiments, the pusher pad 118 may include suction cups in order to better grasp objects having smooth, flat surfaces. In some embodiments, the pusher pads 118 may be configured with sweeping bristles. These sweeping bristles may assist in moving small objects from the floor up onto the scoop 110. In some embodiments, the sweeping bristles may angle down and inward from the pusher pads 118, such that, when the pusher pads 118 sweep objects toward the scoop 110, the sweeping bristles form a ramp, allowing the foremost bristles to slide beneath the object, and direct the object upward toward the pusher pads 118, facilitating capture of the object within the scoop and reducing a tendency of the object to be pressed against the floor, increasing its friction and making it more difficult to move.

The capture and containment system 108, as well as some portions of the sensing system 106, may be mounted atop a lifting column 132, such that these components may be raised and lowered with respect to the ground to facilitate performance of complex tasks. A lifting column linear actuator 162 may control the elevation of the capture and containment system 108 by extending and retracting the lifting column 132. A lifting column motor 176 may allow the lifting column 132 to rotate so that the capture and containment system 108 may be moved with respect to the tidying robot 100 base or chassis 102 in all three dimensions.

The tidying robot 100 may include floor cleaning components such as a mop pad 134 and a vacuuming system. The mop pad 134 may be able to raise and lower with respect to the bottom of the tidying robot 100 chassis 102, so that it may be placed in contact with the floor when desired. The mop pad 134 may include a drying element to dry wet spots detected on the floor. In one embodiment, the tidying robot 100 may include a fluid reservoir, which may be in contact with the mop pad 134 and able to dampen the mop pad 134 for cleaning. In one embodiment, the tidying robot 100 may be able to spray cleaning fluid from a fluid reservoir onto the floor in front of or behind the tidying robot 100, which may then be absorbed by the mop pad 134.

The vacuuming system may include a vacuum compartment 138, which may have a vacuum compartment intake port 140 allowing cleaning airflow 142 into the vacuum compartment 138. The vacuum compartment intake port 140 may be configured with a rotating brush 144 to impel dirt and dust into the vacuum compartment 138. Cleaning airflow 142 may be induced to flow by a vacuum compartment fan 154 powered by a vacuum compartment motor 166. cleaning airflow 142 may pass through the vacuum compartment 138 from the vacuum compartment intake port 140 to a vacuum compartment exhaust port 156, exiting the vacuum compartment 138 at the vacuum compartment exhaust port 156. The vacuum compartment exhaust port 156 may be covered by a grating or other element permeable to cleaning airflow 142 but able to prevent the ingress of objects into the chassis 102 of the tidying robot 100.

A vacuum compartment filter 150 may be disposed between the vacuum compartment intake port 140 and the vacuum compartment exhaust port 156. The vacuum compartment filter 150 may prevent dirt and dust from entering and clogging the vacuum compartment fan 154. The vacuum compartment filter 150 may be disposed such that blocked dirt and dust are deposited within a dirt collector 146. The dirt collector 146 may be closed off from the outside of the chassis 102 by a dirt release latch 148. The dirt release latch 148 may be configured to open when the tidying robot 100 is docked at a base station 300 with a vacuum emptying system 314, as is illustrated in FIG. 3A and FIG. 3B and described below. A robot charge connector 158 may connect the tidying robot 100 to a base station charge connector 310, allowing power from the base station 300 to charge the tidying robot 100 battery 160.

FIG. 2A and FIG. 2B illustrate a simplified side view and top view of a chassis 102, respectively, in order to show in more detail aspects of the mobility system 104, the sensing system 106, and the communications 206, in connection with the robotic control system 1000. In some embodiments, the communications 206 may include the network interface 1012 described in greater detail with respect to robotic control system 1000.

In one embodiment, the mobility system 104 may comprise a left front wheel 168b and a right front wheel 168a powered by mobility system motor 164, and a single rear wheel 168c, as illustrated in FIG. 1A and FIG. 1B. The single rear wheel 168c may be actuated or may be a passive roller or caster providing support and reduced friction with no driving force.

In one embodiment, the mobility system 104 may comprise a right front wheel 168a, a left front wheel 168b, a right rear wheel 208, and a left rear wheel 210. The tidying robot 100 may have front-wheel drive, where right front wheel 168a and left front wheel 168b are actively driven by one or more actuators or motors, while the right rear wheel 208 and left rear wheel 210 spin on an axle passively while supporting the rear portion of the chassis 102. In another embodiment, the tidying robot 100 may have rear-wheel drive, where the right rear wheel 208 and left rear wheel 210 are actuated and the front wheels turn passively. In another embodiment, the tidying robot 100 may have additional motors to provide all-wheel drive, may use a different number of wheels, or may use caterpillar tracks or other mobility devices in lieu of wheels.

The sensing system 106 may further comprise cameras such as the front left camera 188a, rear left camera 188b, front right camera 188c, rear right camera 188d, and scoop camera 188c, light detecting and ranging (LIDAR) sensors such as lidar sensors 202, and inertial measurement unit (IMU) sensors, such as IMU sensors 204. In some embodiments, there may be a single front camera and a single rear camera.

FIG. 3A and FIG. 3B illustrate a base station 300 in accordance with one embodiment. FIG. 3A shows a left side view and FIG. 3B shows a top view. The base station 300 may comprise an object collection bin 302 with a storage compartment 304 to hold tidyable objects, heavy dirt and debris, or other obstructions. The storage compartment 304 may be formed by bin sides 306 and a bin base 308. “Tidyable objects” in this disclosure are elements detected in the environment that may be moved by the robot and put away in a home location. These objects may be of a type and size such that the robot may autonomously put them away, such as toys, clothing, books, stuffed animals, soccer balls, garbage, remote controls, keys, cellphones, etc. The base station 300 may further comprise a base station charge connector 310, a power source connection 312, and a vacuum emptying system 314 including a vacuum emptying system intake port 316, a vacuum emptying system filter bag 318, a vacuum emptying system fan 320, a vacuum emptying system motor 322, and a vacuum emptying system exhaust port 324.

The object collection bin 302 may be configured on top of the base station 300 so that a tidying robot 100 may deposit objects from the scoop 110 into the object collection bin 302. The base station charge connector 310 may be electrically coupled to the power source connection 312. The power source connection 312 may be a cable connector configured to couple through a cable to an alternating current (AC) or direct current (DC) source, a battery, or a wireless charging port, as will be readily apprehended by one of ordinary skill in the art. In one embodiment, the power source connection 312 is a cable and male connector configured to couple with 120V AC power, such as may be provided by a conventional U. S. home power outlet.

The vacuum emptying system 314 may include a vacuum emptying system intake port 316 allowing vacuum emptying airflow 326 into the vacuum emptying system 314. The vacuum emptying system intake port 316 may be configured with a flap or other component to protect the interior of the vacuum emptying system 314 when a tidying robot 100 is not docked. A vacuum emptying system filter bag 318 may be disposed between the vacuum emptying system intake port 316 and a vacuum emptying system fan 320 to catch dust and dirt carried by the vacuum emptying airflow 326 into the vacuum emptying system 314. The vacuum emptying system fan 320 may be powered by a vacuum emptying system motor 322. The vacuum emptying system fan 320 may pull the vacuum emptying airflow 326 from the vacuum emptying system intake port 316 to the vacuum emptying system exhaust port 324, which may be configured to allow the vacuum emptying airflow 326 to exit the vacuum emptying system 314. The vacuum emptying system exhaust port 324 may be covered with a grid to protect the interior of the vacuum emptying system 314.

FIG. 4A illustrates a tidying robot 100 such as that introduced with respect to FIG. 1A disposed in a lowered scoop position and lowered pusher position 400a. In this configuration, the pusher pads 118 and pusher pad arms 120 rest in a lowered pusher position 404, and the scoop 110 and scoop arm 114 rest in a lowered scoop position 406 at the front 402 of the tidying robot 100. In this position, the scoop 110 and pusher pads 118 may roughly describe a containment area 410 as shown.

FIG. 4B illustrates a tidying robot 100 with a lowered scoop position and raised pusher position 400b. Through the action of servos or other actuators at the pad pivot points 122 and pad arm pivot points 124, the pusher pads 118 and pusher pad arms 120 may be raised to a raised pusher position 408 while the scoop 110 and scoop arm 114 maintain a lowered scoop position 406. In this configuration, the pusher pads 118 and scoop 110 may roughly describe a containment area 410 as shown, in which an object taller than the scoop 110 height may rest within the scoop 110 and be held in place through pressure exerted by the pusher pads 118.

Pad arm pivot points 124, pad pivot points 122, scoop arm pivot points 116 and scoop pivot points 112 (as shown in FIG. 7) may provide the tidying robot 100 a range of motion of these components beyond what is illustrated herein. The positions shown in the disclosed figures are illustrative and not meant to indicate the limits of the robot's component range of motion.

FIG. 4C illustrates a tidying robot 100 with a raised scoop position and raised pusher position 400c. The pusher pads 118 and pusher pad arms 120 may be in a raised pusher position 408 while the scoop 110 and scoop arm 114 are in a raised scoop position 412. In this position, the tidying robot 100 may be able to allow objects drop from the scoop 110 and pusher pad arms 120 to an area at the rear 414 of the tidying robot 100.

The carrying position may involve the disposition of the pusher pads 118, pusher pad arms 120, scoop 110, and scoop arm 114, in relative configurations between the extremes of lowered scoop position and lowered pusher position 400a and raised scoop position and raised pusher position 400c.

FIG. 4D illustrates a tidying robot 100 with pusher pads extended 400d. By the action of servos or other actuators at the pad pivot points 122, the pusher pads 118 may be configured as extended pusher pads 416 to allow the tidying robot 100 to approach objects as wide or wider than the robot chassis 102 and scoop 110. In some embodiments, the pusher pads 118 may be able to rotate through almost three hundred and sixty degrees, to rest parallel with and on the outside of their associated pusher pad arms 120 when fully extended.

FIG. 4E illustrates a tidying robot 100 with pusher pads retracted 400e. The closed pusher pads 418 may roughly define a containment area 410 through their position with respect to the scoop 110. In some embodiments, the pusher pads 118 may be able to rotate farther than shown, through almost three hundred and sixty degrees, to rest parallel with and inside of the side walls of the scoop 110.

FIG. 5A-FIG. 5C illustrate a tidying robot 100 such as that introduced with respect to FIG. 1A. In such an embodiment, the pusher pad arms 120 may be controlled by a servo or other actuator at the same point of connection 502 with the chassis 102 as the scoop arms 114. The tidying robot 100 may be seen disposed in a lowered scoop position and lowered pusher position 500a, a lowered scoop position and raised pusher position 500b, and a raised scoop position and raised pusher position 500c. This tidying robot 100 may be configured to perform the algorithms disclosed herein.

The point of connection shown between the scoop arms 114/pusher pad arms 120 and the chassis 102 is an exemplary position and is not intended to limit the physical location of this point of connection. Such connection may be made in various locations as appropriate to the construction of the chassis 102 and arms, and the applications of intended use.

FIG. 6A-FIG. 6C illustrate a tidying robot 100 such as that introduced with respect to FIG. 1A. In such an embodiment, the pusher pad arms 120 may be controlled by a servo or servos (or other actuators) at different points of connection 602 with the chassis 102 from those controlling the scoop arm 114. The tidying robot 100 may be seen disposed in a lowered scoop position and lowered pusher position 600a, a lowered scoop position and raised pusher position 600b, and a raised scoop position and raised pusher position 600c. This tidying robot 100 may be configured to perform the algorithms disclosed herein.

The different points of connection 602 between the scoop arm and chassis and the pusher pad arms and chassis shown are exemplary positions and not intended to limit the physical locations of these points of connection. Such connections may be made in various locations as appropriate to the construction of the chassis and arms, and the applications of intended use.

FIG. 7 illustrates a tidying robot 100 such as was previously introduced in a front drop position 700. The arms of the tidying robot 100 may be positioned to form a containment area 410 as previously described.

The tidying robot 100 may be configured with a scoop pivot point 112 where the scoop 110 connects to the scoop arm 114. The scoop pivot point 112 may allow the scoop 110 to be tilted forward and down while the scoop arm 114 is raised, allowing objects in the containment area 410 to slide out and be deposited in an area to the front 402 of the tidying robot 100.

FIG. 8 illustrates how the positions of the components of the tidying robot 100 may be configured such that the tidying robot 100 may approach an object collection bin 302 and perform a front dump action 800. The scoop 110 may be raised by scoop arm motor 178, extended by scoop arm linear actuator 170, and tilted by scoop motor 180 so that tidyable objects 802 carried in the scoop 110 may be deposited into the storage compartment 304 of the object collection bin 302 positioned to the front 402 of the tidying robot 100, as is also described with respect to the front drop position 700 of FIG. 7.

FIG. 9 illustrates a tidying robotic system interaction 900 in accordance with one embodiment. The tidying robotic system may include the tidying robot 100, the base station 300, a robotic control system 1000, and logic 1014 that when executed directs the robot to perform the disclosed method. When the tidying robot 100 is docked at a base station 300 having an object collection bin 302, the scoop 110 may be raised and rotated up and over the tidying robot 100 chassis 102, allowing tidyable objects 802 in the scoop 110 to drop into the storage compartment 304 of the object collection bin 302 to the rear 414 of the tidying robot 100 in a rear dump action 902, as is also described with respect to the raised scoop position and raised pusher position 400c and raised scoop position and raised pusher position 500c described with respect to FIG. 4C and FIG. 5C, respectively.

In a docked state, the robot charge connector 158 may electrically couple with the base station charge connector 310 such that electrical power from the power source connection 312 may be carried to the battery 160, and the battery 160 may be recharged toward its maximum capacity for future use.

When the tidying robot 100 docks at its base station 300, the dirt release latch 148 may lower, allowing the vacuum compartment 138 to interface with the vacuum emptying system 314. Where the vacuum emptying system intake port 316 is covered by a protective element, the dirt release latch 148 may interface with that element to open the vacuum emptying system intake port 316 when the tidying robot 100 is docked. The vacuum compartment fan 154 may remain inactive or may reverse direction, permitting or compelling airflow 904 through the vacuum compartment exhaust port 156, into the vacuum compartment 138, across the dirt collector 146, over the dirt release latch 148, into the vacuum emptying system intake port 316, through the vacuum emptying system filter bag 318, and out the vacuum emptying system exhaust port 324, in conjunction with the operation of the vacuum emptying system fan 320. The action of the vacuum emptying system fan 320 may also pull airflow 906 in from the vacuum compartment intake port 140, across the dirt collector 146, over the dirt release latch 148, into the vacuum emptying system intake port 316, through the vacuum emptying system filter bag 318, and out the vacuum emptying system exhaust port 324. In combination, airflow 904 and airflow 906 may pull dirt and dust from the dirt collector 146 into the vacuum emptying system filter bag 318, emptying the dirt collector 146 for future vacuuming tasks. The vacuum emptying system filter bag 318 may be manually discarded and replaced on a regular basis.

FIG. 10 depicts an embodiment of a robotic control system 1000 to implement components and process steps of the systems described herein. Some or all portions of the robotic control system 1000 and its operational logic may be contained within the physical components of a robot and/or within a cloud server in communication with the robot and/or within the physical components of a user's mobile computing device, such as a smartphone, tablet, laptop, personal digital assistant, or other such mobile computing devices. In one embodiment, aspects of the robotic control system 1000 on a cloud server and/or user's mobile computing device may control more than one robot at a time, allowing multiple robots to work in concert within a working space.

Input devices 1004 (e.g., of a robot or companion device such as a mobile phone or personal computer) comprise transducers that convert physical phenomena into machine internal signals, typically electrical, optical, or magnetic signals. Signals may also be wireless in the form of electromagnetic radiation in the radio frequency (RF) range but also potentially in the infrared or optical range. Examples of input devices 1004 are contact sensors which respond to touch or physical pressure from an object or proximity of an object to a surface, mice which respond to motion through space or across a plane, microphones which convert vibrations in the medium (typically air) into device signals, scanners which convert optical patterns on two or three-dimensional objects into device signals. The signals from the input devices 1004 are provided via various machine signal conductors (e.g., busses or network interfaces) and circuits to memory 1006.

The memory 1006 is typically what is known as a first- or second-level memory device, providing for storage (via configuration of matter or states of matter) of signals received from the input devices 1004, instructions and information for controlling operation of the central processing unit or processor 1002, and signals from storage devices 1010. The memory 1006 and/or the storage devices 1010 may store computer-executable instructions and thus forming logic 1014 that when applied to and executed by the processor 1002 implement embodiments of the processes disclosed herein. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic 1014 may include portions of a computer program, along with configuration data, that are run by the processor 1002 or another processor. Logic 1014 may include one or more machine learning models 1016 used to perform the disclosed actions. In one embodiment, portions of the logic 1014 may also reside on a mobile or desktop computing device accessible by a user to facilitate direct user control of the robot.

Information stored in the memory 1006 is typically directly accessible to the processor 1002 of the device. Signals input to the device cause the reconfiguration of the internal material/energy state of the memory 1006, creating in essence a new machine configuration, influencing the behavior of the robotic control system 1000 by configuring the processor 1002 with control signals (instructions) and data provided in conjunction with the control signals.

Second- or third-level storage devices 1010 may provide a slower but higher capacity machine memory capability. Examples of storage devices 1010 are hard disks, optical disks, large-capacity flash memories or other non-volatile memory technologies, and magnetic memories.

In one embodiment, memory 1006 may include virtual storage accessible through a connection with a cloud server using the network interface 1012, as described below. In such embodiments, some or all of the logic 1014 may be stored and processed remotely.

The processor 1002 may cause the configuration of the memory 1006 to be altered by signals in storage devices 1010. In other words, the processor 1002 may cause data and instructions to be read from storage devices 1010 in the memory 1006 which may then influence the operations of processor 1002 as instructions and data signals, and which may also be provided to the output devices 1008. The processor 1002 may alter the content of the memory 1006 by signaling to a machine interface of memory 1006 to alter the internal configuration and then converted signals to the storage devices 1010 alter its material internal configuration. In other words, data and instructions may be backed up from memory 1006, which is often volatile, to storage devices 1010, which are often non-volatile.

Output devices 1008 are transducers that convert signals received from the memory 1006 into physical phenomena such as vibrations in the air, patterns of light on a machine display, vibrations (i.e., haptic devices), or patterns of ink or other materials (i.e., printers and 3-D printers).

The network interface 1012 receives signals from the memory 1006 and converts them into electrical, optical, or wireless signals to other machines, typically via a machine network. The network interface 1012 also receives signals from the machine network and converts them into electrical, optical, or wireless signals to the memory 1006. The network interface 1012 may allow a robot to communicate with a cloud server 1022 containing logic 1014, a mobile device, other robots, and other network-enabled devices.

In one embodiment, a global database 1018 may provide data storage available across the devices that comprise or are supported by the robotic control system 1000. The global database 1018 may include maps, robotic instruction algorithms, robot state information, static, movable, and tidyable object reidentification fingerprints, labels, and other data associated with known static, movable, and tidyable object reidentification fingerprints, or other data supporting the implementation of the disclosed solution. The global database 1018 may be a single data structure or may be distributed across more than one data structure and storage platform, as may best suit an implementation of the disclosed solution. In one embodiment, the global database 1018 is coupled to other components of the robotic control system 1000 through a wired or wireless network, and in communication with the network interface 1012.

In one embodiment, a robot instruction database 1020 may provide data storage available across the devices that comprise or are supported by the robotic control system 1000. The robot instruction database 1020 may include the programmatic routines that direct specific actuators of the tidying robot, such as are described previously, to actuate and cease actuation in sequences that allow the tidying robot to perform individual and aggregate motions to complete tasks.

FIG. 11A-FIG. 11E illustrate an item placement procedure 1100 in accordance with one embodiment. Steps 1102a-1102n illustrate the actions a tidying robot 100 may take to approach a tabletop or countertop 1104, remove an obstruction 1106 such as a dirty cup 1108, and place it at a destination 1110, such as a dishwasher 1112. In step 1102a, the tidying robot 100 may approach 1114 the countertop 1104 through the action of the mobility system 104. The tidying robot 100 may have its pusher pads 118 extended in front of the scoop 110. The lifting column 132 may be elevated such that the bottom of the scoop 110 is level with and slightly above the top of the countertop 1104.

In step 1102b, the tidying robot 100 may continue to approach 1116 the countertop 1104 and the cup 1108 with the first pusher pad 1118 rotated inward 1122 at a first pad pivot point 1124 by a first pusher pad motor 1126 toward the front edge 1128 of the scoop 110, and parallel to or angled toward that front edge 1128. The second pusher pad 1120 may be open and pointing forward as shown or may be rotated outward at a second pad pivot point 1130 by a second pusher pad motor 1132 to be further away from the scoop 110 front edge 1128. In step 1102c, the tidying robot 100 may drive forward or may extend 1134 the scoop arm linear actuator 170, and/or the first pusher pad arm 1136 using the first pusher pad arm linear actuator 1138 and the second pusher pad arm 1140 using the second pusher pad arm linear actuator 1142, horizontally forward until the cup 1108 is in contact with the first pusher pad 1118.

In step 1102d, the tidying robot 100 may close 1144 the second pusher pad 1120 so that the cup 1108 is held firmly between the first pusher pad 1118 and the second pusher pad 1120. The first pusher pad arm motor 1146 at the base of the first pusher pad arm 1136 and the second pusher pad arm motor 1148 at the base of the second pusher pad arm 1140 may be rotated to lift the cup 1108 slightly up and off of the countertop 1104. The cup 1108 may be positioned slightly above the level of the front edge 1128 of the scoop 110. In step 1102c, the pusher pad arm linear actuators 172 may retract 1150 so that the cup 1108 passes above the front edge 1128 into an area fully above the scoop 110. The first and second pusher pad arm motors 184 may rotate to lower the cup 1108 onto the scoop 110.

In step 1102f, the tidying robot 100 may plan and execute an approach path 1152, using the mobility system 104 to drive from the countertop 1104 to the destination 1110, such as the dishwasher 1112. The destination 1110 may have an access panel 1154 with a handle 1156 allowing access to an interior of the destination 1158, such as a dishwasher door 1160. The destination 1110 may include storage platforms 1162 such as dishwasher trays 1164. During path planning and navigation, the tidying robot 100 may hold the cup 1108 securely in the scoop 110 with the pusher pads 118. In step 1102g, the tidying robot 100 may rotate and extend 1166 the gripper arm 128 underneath the scoop 110 so that the gripper arm 128 or actuated gripper 126 may grab the handle 1156 of the dishwasher door 1160.

In step 1102h, the tidying robot 100 may retract and potentially rotate 1168 the gripper arm 128 to begin opening the dishwasher 1112. The tidying robot 100 may then retract the lifting column linear actuator 162 to lower 1170 the lifting column 132 while backing up 1172 using its mobility system 104 to fully open the dishwasher door 1160. In step 1102i, the tidying robot 100 may use the gripper arm 128 or actuated gripper 126 to pull out 1174 one of the dishwasher trays 1164 while still holding the cup 1108 securely in the scoop 110. This action may be performed through similar forward and backward motions of the tidying robot 100 along with extension, retraction, and rotation of the gripper arm 128, raising and lowering of the lifting column 132, etc.

In step 1102j, the tidying robot 100 may extend the scoop arm linear actuator 170 of the scoop arm 114 so that the scoop 110 is over the dishwasher tray 1164. The scoop motor 180 may rotate 1178 so that the scoop 110 begins to invert 1176. At this time, the first pusher pad 1118 and second pusher pad 1120 may still apply firm pressure to the cup 1108. In step 1102k, the scoop motor 180 may continue to rotate 1178 the scoop 110 so that the cup 1108 is held in a partially inverted position 1180 slightly above the dishwasher tray 1164 while the cup is still held securely in the scoop 110.

In step 11021, the first pusher pad 1118 may rotate slightly through the action of its first pusher pad arm motor 1146, and the first pusher pad arm linear actuator 1138 may extend slightly as shown, moving the cup 1108 slowly out of the scoop 110 and onto the dishwasher tray 1164. The first pusher pad 1118 and second pusher pad 1120 may maintain firm pressure on the cup 1108 as it is being moved to keep its motion steady and controlled. In step 1102m, the cup 1108 may now rest safely on the dishwasher tray 1164. The tidying robot 100 may push the dishwasher tray 1164 back into the dishwasher 1112 and close the dishwasher door 1160 through coordinated operation of the mobility system 104, gripper arm 128, lifting column 132, etc., in a manner similar to the steps previously described.

In step 1102n, now that the cup 1108 is in the dishwasher 1112, the dishwasher door 1160 is closed, and the handle 1156 is released, the tidying robot 100 may plan a path to return to the countertop to pick up another dish to put in the dishwasher 1112, to navigate to a base station, or to perform other tidying tasks. Once the dishwasher 1112 has completed washing the cup 1108, it may be removed from the dishwasher 1112 using steps similar to those implemented to remove the cup 1108 from the countertop 1104.

One of ordinary skill in the art will appreciate that, while the first pusher pad is shown here to be the left pusher pad and the second pusher pad is illustrated as the right pusher pad, the actions described here and elsewhere in this disclosure may be performed as readily with the right pusher pad being the first and the left the second. The designations “first,” “second,” “right,” and “left” used herein are not intended to limit the performance of these actions to a specifically sided sequence of motion for the tidying robot 100.

FIG. 12A-FIG. 12D illustrate an item removal procedure 1200 in accordance with some embodiments. The item removal procedure 1200 shows the general purpose tidying robot unloading the dishwasher, and putting the cup it picks up onto a shelf or into a cupboard. In step 1200a, the pusher pads of a tidying robot grip a cup 1202 that is on a storage tray 1204 in the dishwasher. In some embodiments, a first pusher pad is rotated inward toward a front edge of the scoop. The tidying robot approaches the cup 1202 and stops when the cup 1202 is positioned between the pusher pads and contacts the inward rotated first pusher pad. Next, the second pusher pad is rotated until the second pusher pad contacts the cup 1202. In step 1200b, the cup is lifted off of the storage tray 1204 using the pusher pads. In step 1200c, the cup is moved onto the scoop by retracting the pusher pad arms.

After the cup 1202 has been transport to a shelf or cupboard, in step 1200d, the scoop is placed near the edge of the shelf followed by step 1200e, where the cup pushed off of the scoop and onto the shelf by extending the pusher pad arms. In step 1200f, the pusher pads release the cup onto the shelf, followed by step 1200g, where the pusher pads are raised up above the cup. In step 1200h, the scoop is removed from the shelf by backing up the tidying robot.

FIG. 13A-FIG. 13H illustrate an item removal procedure 1300 in accordance with some embodiments. The item removal procedure 1300 shows how to unload multiple plates 1302. In step 1300a, the pusher pad arms are positioned immediately above the plate 1302 followed by step 1300b, where the pusher pad arms are lowered so that the plate 1302 is encapsulated. The pusher pad arms close in step 1300c in order to grasp the plate 1302. Next, in step 1300d, the plate 1302 is lifted vertically using the lifting column linear actuator. In step 1300e, the pusher pad arms move the plate into the scoop while also, in some embodiments, lowering the scoop to minimize the distance above the dishwasher storage tray. In step 1300f, after the plate is removed from the dishwasher, it is initially held between the pusher pads. In order to start the movement of the plate to a flat position in the bottom of the scoop, in step 1300f, the scoop is tilted back slightly and the lower pusher arm is retraced and rotated down so that the plate moves towards the bottom of the scoop. Next, in step 1300h, the free pusher pad is used to block the front of the scoop so that the plate 1302 cannot slide off of the scoop. In step 1300i, the pusher pad arm under the plate is extended towards the front of the scoop so that it is no longer under the plate. In some embodiments, the scoop is further tilted back so that the plate falls towards the back of scoop and may minimize the impact force of plate falling off of pusher pad into the scoop. According to step 1300j, the scoop may be tilted forward, moving the plate towards the front of the scoop so that a pusher pad arm may be placed behind the plate. In step 1300k, the pusher arms are moved together to hold the plate with one pusher pad arm in front of the plate and the second pusher pad arm behind the plate. In step 13001, the plate is manipulated such that it is flat in the scoop and slightly forward so that a pusher pad arm can go behind it. In step 1300m, the scoop is positioned immediately next to a stack of plates followed by step 1300n, where the pusher pad arms are used to move the plate to a position immediately above the stack of plates. The pusher arms are opened to place the plate onto the stack of plates in step 13000.

FIG. 14 illustrates an item removal procedure 1400 in accordance with some embodiments. FIG. 14 shows an alternative what of unloading plates from the dishwasher. In step 1400a of this embodiment, the pusher pad arms are rotated to lift the plate, which keeps the scoop closer to the dishwasher rack. This procedure may keep the plate just above the dishwasher rack and scoop so that it is unlikely to be damaged even if dropped. In step 14, the pusher pads are used to move the plate into the scoop while also lowering the scoop to minimize the distance above the dishwasher rack.

FIG. 15A illustrates an item flipping procedure 1500 in accordance with some embodiments. If a plate has the wrong side up in the scoop then it needs to be flipped before putting it away on a shelf or in a cupboard. In step 1500a, the lower pusher pad arm is retracted so that the plate is not tightly held. Next, in an embodiment shown in step 1500b, the upper and lower pusher pad arms are rotated up toward the top of the plate, where they grasp the edge of the top of the plate. In step 1500c, while keeping a grip on the plate, the pusher arms are extended so that the corner of the plate move to the corner of the scoop. In an embodiment, the plate stays close to the scoop during this maneuver with the pusher arms staying close to the back of the scoop. Next, in step 1500d, the pusher pad arms are rotated, along the plate, from the back of the scoop to the front of the scoop. In step 1500e, the pusher pad arm that is located under the plate is extended, allowing the plate to gently fall onto the scoop, completing the flip maneuver. In some embodiments, the scoop may be kept tilted back to minimize the impact force of the plate falling into the scoop.

FIG. 16A illustrates an item flipping procedure 1600 in accordance with some embodiments. A second type of plate flipping procedure may begin in step 1600a with grabbing the top of the plate when unloading the plate from a dishwasher. In step 1600b, the pusher pad arms are retracted and rotated, moving the plate above the scoop. In some embodiments, the top of the plate is in contact with the back of the scoop and the bottom of the plate is not in contact with the scoop. In step 1600c, while maintaining pressure on the plate, one of the pusher arm is rotated slightly downwards, causing the corner of the plate to move into a corner of the scoop. This maneuver is similar to the process that occurs if a book is held between ones fingers, and ones fingertips are moved slightly up and slightly down, resulting in moving the bottom edge back and forth in a swinging motion. In step 1600d, the pusher pad arms are rotated from the back of the scoop to the front of the scoop. The flipping maneuver is completed in step 1600e where the pusher pad arm that is under the plate is extended towards the front of the scoop.

FIG. 17 illustrates scoop walls 1700 in accordance with some embodiments. The pusher pads may be designed so that they can go over the sides of the scoop and manipulate objects within the scoop. In some embodiments, drawings in this disclosure may show what appears to be interference between the scoop sides and where the pusher pads connect with the pusher pad arms. In exemplary embodiments, these may be addressed by one or move of:
Slightly lowering the scoop wall in the sketches so that there isn't any interference.
Raising the connection point between the pusher pads and the pusher pad arms so they can reach over a higher scoop wall.
Performing the same actions to manipulate the plates, but simply keeping the pusher pad connection point above the scoop wall to avoid interference.
Folding in the scoop walls before picking up the plates to avoid any interference.

FIG. 17 illustrates an embodiment with lower scoop walls 1702 so that the pusher pad connection points are able to go over the top in many pusher pad configurations without interfering.

FIG. 18A illustrates a cutlery removal and sorting procedure 1800 in accordance with some embodiments. When unloading a dishwasher, the general purpose tidying robot may use a clean surface, such as a countertop, to sort the cutlery by category. In step 1800a, pusher pads are closed around cutlery, located in basket, to pick it up, followed by moving the cutlery into the scoop of the tidying robot in step 1800b. If the cutlery items are released into the scoop by the pusher pads, unsorted cutlery will result in the scoop as shown in step 1800c. In an embodiment, the cutlery is dumped onto a clean sorting surface in step 1800d by lifting the rear of the scoop and allowing the cutlery to slide out of the scoop. According to some embodiments, in step 1800e, the tidying robot is turned so that is is able to drive parallel to the sorting surface and the scoop of the robot is turned, with a rotational actuator at a base of the lifting column, such that the front edge of the scoop is parallel with the front edge of the surface. In step 1800f, the pusher pad is lifted slightly above the sorting surface, leaving a gap so that there is just enough space for the cutlery to fit through the gap. The tidying robot may drive along the edge of the sorting surface, spreading out cutlery. In step 1800g and step 1800h, the process of spreading out cutlery is repeated until the cutlery is sufficiently spaced for individual selection. In step 1800j to step 1800n, the pusher pads may be used in a V-shape to pick up individual cutlery by category. In some embodiments, a typical pickup pattern may be used where an opening is made between the pusher pads and they are extended out to pick up individual pieces of cutlery and place them into the scoop. Optionally, the pusher pads may be used to rotate the cutlery so that they have the same orientation. After collecting a desired category of cutlery into the scoop, the collected cutlery may be placed into a cutlery tray slot in step 18000, by using the pusher arms in a V-shape configuration inside the scoop to direct cutlery into a cutlery tray slot by category. The gap in the V-shaped pusher pads is aligned with a desired cutlery tray slot. In step 1800p, the scoop is tilted forward so that tips of cutlery fall into the desired cutlery slot. Next, in step 1800q, the scoop is moved backwards while slightly increasing the tilt angle of the scoop, directing the cutlery between the pusher pads into the cutlery slot. This may be accomplished by retracting a scoop arm linear actuator or reversing the tidying robot. In some embodiments, because the tips of the cutlery are already in the cutlery slot, this provides some friction that helps the cutlery move out of the scoop. In step 1800r, the front edge of the scoop is moved to the back of the cutlery slot while tilting the scoop forward, resulting in all of the cutlery resting fully in the cutlery slot.

FIG. 19A illustrates a cutlery sorting procedure 1900 in accordance with some embodiments. In an alternative method of placing cutlery into a cutlery slot by category, step 1900a configures pusher pads in the scoop so that a first pusher pad is flat against the front edge and the second pusher pad is in a position to facilitate directing the cutlery towards one side at around a 45 degree angle. In step 1900b, the scoop is tilted back, moving the cutlery to the back of the scoop. In step 1900c, the scoop is tilted forward, allowing the cutlery to gather behind the first pusher pad, while the second pusher pad pusher pad directs the cutlery toward the first pusher pad. In step 1900d, the front edge of the scoop is positioned next to a long side of the cutlery tray slot while keeping the scoop tilted forward so that cutlery is flat against the first pusher pad. In step 1900e, the right pusher pad is rotated up slightly while extending the right pusher pad arm so that the pusher pad moves to the other side of the cutlery try slot. In some embodiments, the second pusher pad is rotated slightly out of the scoop. According to an embodiment, in step 1900f, the cutlery falls into the cutlery tray slot because the scoop is tilted forward.

FIG. 20 illustrates an item loading procedure 2000 in accordance with some embodiments. Actuators at end of pusher arms may be switched out for different actuators. In some embodiments, a multi-purpose soft gripper (either 2 finger or 3 finger) is typically included at the end of the arms with the general purpose tidying robot that can be used for grasping fabric, or picking up small objects to help move them on/off the scoop in a controlled way.

Including grippers (or other end-effectors) at the end of the pusher arms may be very useful in accomplishing many tasks with the general purpose tidying robot. However, different types of grippers (or end effectors) may work better for accomplishing different tasks.

As such, it may be useful to have Swiss army knife type of functionality in gripper (or end effector) attachments that can be connected to the of the pusher arms either with some sort of release and attachment mechanism, or with a mechanism where different types of grippers (or end effectors) fold-out from a storage compartment for use when needed.

Some examples include the following:
Fabric gripper: uses clamping, friction, and/or air/suction to manipulate textiles or soft materials.
Suction cup or vacuum gripper: uses suction cups (potentially in a grid) for flat or smooth items.
Magnetic gripper: picks up metal objects using magnetism.
Soft gripper: flexible, for delicate or irregular objects.
Three-finger gripper: wraps around cylindrical or irregular shapes.
Parallel VS angular gripper: jaws move in parallel VS jaws pivot to open/close.

In situations especially where there's a release and attachment mechanism then specialized tooling may also be incorporated in some situations such as:
Vacuum hose end effector
Cleaning spray end effector
Squeegee tool end effector
Sponge or surface wiping end effector
Brush attachment
Duster attachment
Mop attachment
Spray nozzle end effector
Screwdriver or drill end effector
Special camera or sensor module attachment
Carabiner attachment
Welding torch end effector
3D printing extruder end effector

Such optional tooling may extend the general purpose tidying robot to be used in other settings and to perform other tasks such as in warehouses, manufacturing production lines, businesses and/or industrial.

In an embodiment, FIG. 20 illustrates an example where a multi-purpose soft gripper 2004 at the end of the pusher pad 2006 may assist with placing a cups 2002 into a dishwasher. In an embodiment, step 2000a illustrates a cup 2002 being held by soft grippers 2004 on a handle of the cup and the top lip of the cup, while in the scoop of a tidying robot. In some embodiments, only one of the handle or the top lip may be held by the soft grippers 2004. In step 2000b, the scoop holding the cup 2002 is inverted while the cup is being held against the bottom of the scoop by the soft grippers 2004 and/or the pusher pads.

When manipulating objects with the general purpose tidying robot such as having it fold clothing, pick up dishes or cutlery items, or open appliance doors, the robot may often use a deep learning model to generate key points for specifically manipulating certain objects, often alongside panoptic segmentation, which labels both whole objects and their individual parts. In some embodiments, these tasks are commonly handled by a single model with a shared backbone and multiple output heads, such as one for segmentation and another for key point detection, enabling efficient joint inference.

In particular, these manipulation key points may often differ from visual key points in that for example the correct fold points on clothing may often simply be along an edge a certain distance from a corner where the corner is visually distinctive, but the fold point is not visually unique.

The following is a discussion of aspects of the key point identification system:

### Core Perception Modules

Segmentation: identify objects and their parts (e.g., shirt vs. sleeve).
Landmarks: detect distinctive points (e.g., corners, handles, rims).
Affordance heatmaps: highlight where actions are possible (grip, hold, push, align).
Keypoint solver: select specific contact points, respecting constraints (offset from corner, symmetry, opposing sides).

Task Configuration (Recipes) Each task is defined as a recipe made of steps. A step specifies:
Action type (grip, hold, lift, align).
Target object/part (shirt hem, pant leg, pot lid).
Constraints (e.g., “on edge,” “10 cm from corner,” “symmetric pair”).
End-effector type (gripper, scoop, pad).
Next step (what follows once this action is done).

This separates what to do (recipe) from how to see and act (perception+solver).

### Control & Planning

Step planner: reads the current step from the recipe.
Motion planner: turns chosen key points into robot motions.
State updater: records progress (which folds done, whether lid removed, etc.).

Learning Loops (Continuous Improvement) The robot improves over time using three complementary approaches:
1. Imitation Learning (IL)
   Learn initial behaviors from human demonstrations.
   Fast way to bootstrap skills.
1. Self-Supervised Learning
   Robot interacts with objects and learns from the outcomes (e.g., pulling on cloth to see how it moves).
   Improves perception and generalization without human labels.
1. Reinforcement & Human Corrections
   Rewards from task success (e.g., neat fold, stable pot lift).
   Human corrections can guide the robot without giving full new demos.
   Refines skills beyond what was demonstrated.

### Runtime Workflow

1. Perception: segmentation, landmarks, affordances.
2. Step selection: read the next step from the recipe.
3. Keypoint solver: pick exact manipulation points under step constraints.
4. Motion execution: plan and perform the action.
5. Feedback: log success/failure; use for imitation, self-supervised, or RL updates.
6. Advance to next step until task is complete.

### Summary

Configurable: new tasks only require a new recipe file.
Reusable perception: segmentation, landmarks, affordances work across tasks.
Improves over time: imitation to start, self-supervision for generalization, reinforcement/corrections for refinement.
Step-wise execution: robot only focuses on the next action, reducing complexity.

### Example Configuration

task: fold_pants steps: -step: fold_leg_over action: grip target: pant_leg constraints: {fold_over: other_leg} end_effector: gripper next: fold_ankles_up -step: fold_ankles_up action: grip target: pant_ankles constraints: {fold_towards: waist} end_effector: gripper next: optional_stack-step: optional_stack action: grip target:
folded_pants constraints: {fold_towards: half_height} end_effector: gripper next: done task: fold_shirt steps: -step: fold_left_side action: grip target: shirt_hem constraints: {offset_from_corner: 10 cm, edge_aligned: true} end_effector: gripper next: fold_right_side -step: fold_right_side action: grip target: shirt_hem constraints: {symmetric_to: fold_left_side} end_effector: gripper next: fold_bottom -step: fold_bottom action: grip target: shirt_hem constraints: {fold_towards: collar} end_effector: gripper next: done
task: fold_pants steps: -step: fold_leg_over action: grip target: pant_leg constraints: {fold_over: other_leg}

### Moving a Pot to the Scoop:

task: move_pot_to_scoop steps: -step: place_lift_pads action: hold target: pot_rim constraints: {two_points_opposite: true} end_effector: pads s next: slide_pot step: slide_pot action: translate target: scoop_surface constraints: {path: countertop_to_scoop, scoop_aligned: true} end_effector: pads next: release_pot -step: release_pot action: release target: pot constraints: {stable_on: scoop_surface} end_effector: pads next: done

### Segmentation

What: Split the image into objects and their parts, for example shirt body and sleeves, or pot and lid.
Why: Actions target specific parts, so the robot needs clear masks and edges.

### Landmarks

What: Distinctive points on the object such as corners, handles, or rim points.
Why: They provide anchors for actions like “grip 10 cm from this corner” even if the exact grip point is not visually unique.

### Affordance Heatmaps

What: A map showing which regions are suitable for an action like grip, hold, push, or align.
Why: They highlight feasible zones for the current step, helping the robot focus on where the action will succeed.

### Keypoint Solver

What: A module that converts landmarks and affordance maps into precise contact points and orientations.
Why: It enforces constraints such as “on an edge,” “a fixed offset from a landmark,” “symmetric pairs,” or “two opposing contact points,” ensuring the chosen key points are physically valid and task-appropriate.
   How they Work Together
Segmentation isolates the correct part of the object.
Landmarks identify reference anchors.
Affordance maps highlight suitable regions.
The Keypoint solver selects the exact contact points that satisfy the step's constraints.

The backbone (for example a CNN) processes the image once to extract general visual features. Multiple heads branch from it:
Segmentation head: Predicts object and part masks.
Landmark head: Predicts anchor points such as corners or handles.
Affordance head: {redicts heatmaps showing where specific actions are possible.
Keypoint solver is either:
   A separate solver module that applies explicit rules and constraints (for example “choose a point on the hem edge offset from a corner” or “pick two symmetric points”)·
   A neural head that directly predicts key points from shared features, possibly combined with a lightweight solver to enforce constraints.

This setup is efficient because the robot only runs one forward pass through the backbone, and all perception tasks share the same features. It also helps the model learn better, since tasks like segmentation, landmarks, and affordances reinforce each other.

In some embodiments as shown in FIG. 21, the use of keypoint identification 2100 is used for holding a cup so that it can be inverted into a dishwasher. Key points are shown on a cup 2102 identifying the grip point 2108 where a soft gripper 2004 may be used and a pusher pad point 2110 where a pusher pad may be used to secure the cup 2102. In another example, pusher pads may be used to place or remove a plate vertically into or from the dishwasher, as seen in FIG. 13B. Pusher pad points 2110 are shown on the vertical plate 2104. In yet another scenario, keypoints may assist in grasping a plate to move and stack it on a shelf or in a cupboard as seen in FIG. 13G. Grip points 2108 are shown on the horizontal plate 2106.

FIG. 22 illustrates an example method 2200 for picking up a target object and transporting it. Although the example method 2200, and all of the following examples in the figures below, depicts a particular sequence of operations, the sequence may be altered without departing from the scope of the present disclosure. For example, some of the operations depicted may be performed in parallel or in a different sequence that does not materially affect the function of the method 2200. In other examples, different components of an example device or system that implements the method 2200 may perform functions at substantially the same time or in a specific sequence.

According to some examples, the method includes approaching a target object with a tidying robot at block 2202.

According to some examples, the method includes extending the pusher pads of a scoop out and forward at block 2204.

According to some examples, the method includes exerting pressure on the target object with the pusher pads to hold the target object stationary in the scoop at block 2206.

According to some examples, the method includes raising at least one of the scoop, the pusher pads, and a scoop lifting column linear actuator, holding the target object, to a carrying position at block 2208.

According to some examples, the method includes transporting the target object to a destination for the target object at block 2210.

FIG. 23 illustrates an example method 2300 for loading the target object into a destination.

According to some examples, the method includes rotating and extending a gripper arm toward the handle of a destination at block 2302.

According to some examples, the method includes grabbing the handle with the gripper arm at block 2304.

According to some examples, the method includes partially pulling out a storage platform from the destination at block 2306.

According to some examples, the method includes extending a scoop arm such that the scoop is over the storage platform and contains a target object at block 2308.

According to some examples, the method includes inverting the scoop so that the target object is in a partially inverted position above the storage platform at block 2310.

According to some examples, the method includes extending the first pusher pad arm until the target object rests on the storage platform in an inverted position at block 2312.

According to some examples, the method includes releasing the pusher pads from the target object at block 2314.

FIG. 24 illustrates an example method 2400 for removing a target object from a destination and transporting it.

According to some examples, the method includes opening the access panel of a destination using the gripper arm at block 2402.

According to some examples, the method includes partially pulling out the storage platform from the destination at block 2404.

According to some examples, the method includes extending the pusher pads out and forward at block 2406.

According to some examples, the method includes approaching the target object and coming to a stop when the target object is positioned below and between the pusher pads at block 2408.

According to some examples, the method includes lowering the pusher pads to place the target object in contact with at least one of the pusher pads at block 2410.

According to some examples, the method includes lifting the target object up from the storage platform at block 2412.

According to some examples, the method includes retracting the pusher pad arms to move the target object into the scoop at block 2414.

According to some examples, the method includes transporting the target object to a second destination at block 2416.

FIG. 25 illustrates an example method 2500 for transporting cutlery and sorting it.

According to some examples, the method includes transporting cutlery items to a destination at block 2502.

According to some examples, the method includes releasing the cutlery items from the pusher pads and into the scoop at block 2504.

According to some examples, the method includes tilting the scoop downwards towards the target surface of the destination at block 2506.

According to some examples, the method includes the unsorted cutlery items to fall to the target surface at block 2508.

According to some examples, the method includes orienting the tidying robot so that is can travel parallel to the target surface at block 2510.

According to some examples, the method includes lifting one pusher pad slightly off the sorting surface, leaving a gap with enough space for unsorted cutlery items to fit through at block 2512.

According to some examples, the method includes driving along an edge of the sorting surface spreading out the unsorted cutlery items with the pusher pad at block 2514.

FIG. 26 illustrates an example method 2600 for sorting cutlery items.

According to some examples, the method includes placing the pusher pads into a V-shape to create an opening between the pusher pads at block 2602.

According to some examples, the method includes placing the opening in a position where at least a portion of a first individual piece of cutlery is in the opening at block 2604.

According to some examples, the method includes moving the first individual piece of cutlery into the scoop by using the pusher pads at block 2606.

According to some examples, the method includes placing the opening in the position where at least a portion of a second individual piece of cutlery, at block 2608.

According to some examples, the method includes moving the second individual piece of cutlery into the scoop by using the pusher pads at block 2610.

According to some examples, the method includes transporting the first and second individual pieces of cutlery to a cutlery tray at block 2612.

FIG. 27 illustrates an example method 2700 for placing sorted cutlery into a cutlery tray.

According to some examples, the method includes aligning the scoop with the tray slot for the first type of cutlery at block 2702.

According to some examples, the method includes placing the pusher pads in a V-shape with an opening between the tips no larger than a width of the first tray slot at block 2704.

According to some examples, the method includes tilting the scoop forward to allow a portion of the first cutlery to fall into the first slot at block 2706.

According to some examples, the method includes moving backwards and tilt the scoop forward until all of the first cutlery is in the first slot at block 2708.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A method comprising:
approaching a target object with a tidying robot,
wherein the tidying robot is configured with:
a chassis;
a capture and containment system including:
a scoop;
pusher pads including a first pusher pad and a second pusher pad;
pusher pad arms including a first pusher pad arm and a second pusher pad arm;
a gripper arm;
a lifting column configured to raise and lower the capture and containment system through extension and retraction of a lifting column linear actuator;
raising the capture and containment system, using the lifting column linear actuator to a grabbing height of the target object;
extending the pusher pads out and forward with respect to the pusher pad arms;
rotating the first pusher pad inward toward a front edge of the scoop;
approaching the target object and coming to a stop when the target object is positioned between the pusher pads and contacts the inward rotated first pusher pad;
rotating the second pusher pad until the second pusher pad contacts the target object;
retracting the pusher pad arms to move the target object into a containment area; and
exerting pressure on the target object with the pusher pads to hold the target object stationary in the containment area; and
raising at least one of the scoop, the pusher pads, and the lifting column linear actuator, holding the target object, to a carrying position.

2. The method of claim 1, further comprising:
transporting the target object to a destination for the target object, wherein the destination includes a handle on an access panel for accessing an interior of the destination including a storage platform;
performing at least one of raising and lowering the capture and containment system so that the gripper arm is within reach of the handle on the access panel;
rotating and extending the gripper arm toward the handle;
grabbing the handle with the gripper arm;
retracting the gripper arm and rotating the gripper arm to open the access panel;
retracting the lifting column linear actuator to lower the lifting column while backing up the tidying robot from the access panel to open the access panel;
actuating the gripper arm to grip the storage platform;
partially pulling out the storage platform from the destination using at least one of:
forward and backward motion of the tidying robot;
extension, retraction, and rotation of the gripper arm; and
raising and lowering of the lifting column;
placing the target object on the storage platform, including:
on condition the target object needs to be inverted:
extending a scoop arm linear actuator such that the scoop is over the storage platform;
inverting the scoop so that the target object is in a partially inverted position above and in close proximity to the storage platform;
rotating, away from the scoop, the first pusher pad and extending the first pusher pad arm until the target object rests on the storage platform in an inverted position; and
releasing the first pusher pad and the second pusher pad from the target object;
on condition the target object does not need to be inverted:
extending the scoop arm linear actuator such that the scoop is over the storage platform;
lowering the lifting column until the scoop is at least one of on and above and in close proximity to the storage platform;
extending the first pusher pad arm and the second pusher pad arm until the target object is off of the scoop and rests on the storage platform;
releasing the first pusher pad and the second pusher pad from the target object; and
pushing the storage platform into the destination using at least one of:
forward and backward motion of the tidying robot;
extension, retraction, and rotation of the gripper arm; and
raising and lowering of the lifting column.

3. The method of claim 2, further comprising:
grabbing the handle with the gripper arm;
extending the gripper arm and rotating the gripper arm to close the access panel;
extending the lifting column linear actuator to raise the lifting column while driving the tidying robot forward to close the access panel.

4. The method of claim 2, wherein the destination is a dishwasher and the storage platform is a dishwasher tray in the dishwasher for holding the target object.

5. The method of claim 3, further comprising:
opening the access panel using the gripper arm;
partially pulling out the storage platform from the destination using the gripper arm;
extending the pusher pads out and forward with respect to the pusher pad arms;
rotating the first pusher pad inward toward the front edge of the scoop;
approaching the target object and coming to a stop when the target object is positioned below and between the pusher pads;
lowering the pusher pads to place the target object in contact with at least one of the first pusher pad and the second pusher pad;
rotating the second pusher pad or the first pusher pad until both the second pusher pad and the first pusher pad contact the target object;
lifting the target object up from the storage platform to a height of the containment area;
retracting the pusher pad arms to move the target object into the containment area; and
exerting pressure on the target object with the pusher pads to hold the target object stationary in the containment area; and
raising at least one of the scoop, the pusher pads, and the lifting column linear actuator, holding the target object, to the carrying position;
transporting the target object to a second destination;
placing the containment area near a target surface of the second destination;
moving the target object to a position over the target surface by extending out the pusher pads;
lowering the target object onto the target surface by lowering the pusher pads;
releasing the target object from the pusher pads;
raising the pusher pads above the target object; and
removing the scoop from second destination.

6. The method of claim 5, wherein the destination is a dishwasher, the storage platform is a dishwasher tray in the dishwasher for holding the target object, and the second destination is a shelf or a cupboard.

7. The method of claim 3, further comprising:
opening the access panel using the gripper arm;
partially pulling out the storage platform from the destination using the gripper arm;
extending the pusher pads out and forward with respect to the pusher pad arms;
rotating the first pusher pad inward toward the front edge of the scoop;
approaching the target object and coming to a stop when the target object is positioned below and between the pusher pads, wherein the target object is a plate in a substantially vertical position;
lowering the pusher pads to place the target object in contact with at least one of the first pusher pad and the second pusher pad;
rotating the second pusher pad or the first pusher pad until both the second pusher pad and the first pusher pad contact the target object;
lifting the target object up from the storage platform to a height of the containment area by at least one of:
vertically raising the containment area using the lifting column linear actuator; and
rotating the pusher arms up;
retracting the pusher pad arms to move the target object into the containment area; and
exerting pressure on the target object with the pusher pads to hold the target object stationary in the containment area; and
raising or lowering at least one of the scoop, the pusher pads, and the lifting column linear actuator, holding the target object, to the carrying position;
transporting the target object to a second destination;
on condition the target object does not need to be rotated to a substantially horizontal position:
placing the containment area near a target surface of the second destination;
moving the target object to a position over the target surface by extending out the pusher pads;
lowering the target object onto the target surface by lowering the pusher pads;
releasing the target object from the pusher pads;
raising the pusher pads above the target object; and
removing the scoop from second destination.

8. The method of claim 7, further comprising:
on condition the target object needs to be rotated to a substantially horizontal position:
rotating the target object to the substantially horizontal position while the target object is in the containment area, wherein one pusher pad arm is in front of the target object and the other pusher pad arm is behind the target object;
positioning the scoop immediately next to a desired location on the target surface;
moving the target object, with the pusher pad arms, immediately above the desired location; and
opening the pusher pad arms to release the target object onto the target surface.

9. The method of claim 8, wherein rotating the target object to the substantially horizontal position includes:
tilting the scoop back slightly, wherein in the target object is held at an angle in the containment area with a top portion of the target object near a back of the containment area and a bottom side of the target object near the bottom of the containment area, wherein an upper pusher pad arm is above the other pusher pad arm and a lower pusher pad arm is under the target object;
retracting the lower pusher pad arm and rotating the lower pusher pad down so that the top portion of the target object moves toward the bottom of the scoop;
extending and lowering the upper pusher pad arm to the front edge of the scoop;
extending the lower pusher pad arm forward until it is no longer under the target object;
tilting the scoop forward to move the target object towards the front of the scoop; and
placing the lower pusher pad arm behind the target object.

10. The method of claim 8, wherein rotating the target object to the substantially horizontal position includes:
tilting the scoop back slightly, wherein the target object is held at an angle in the containment area with a top portion of the target object near a back of the containment area and a bottom side of the target object near the bottom of the containment area, wherein one pusher pad is above the other pusher pad and the lower pusher pad is under the target object;
retracting the lower pusher pad arm and rotating the lower pusher pad arm down so that the top portion of the target object moves toward the bottom of the scoop;
rotating and retracting the upper pusher pad arm to a position on the target object near the top portion of the target object and above the bottom pusher pad arm;
extending, and rotating slightly forward, the top pusher pad arm and the bottom pusher pad arm such that an edge of the target object moves to an edge of the scoop and the pusher pad arms remain close to the back of the scoop;
rotating the pusher pad arms, while gripping the target object, from the back of the scoop to the front of the scoop;
extending the pusher pad arm that is under the target object towards the front of the scoop until it is no longer under the target object;
tilting the scoop forward to move the target object towards the front of the scoop; and
placing the pusher pad arm that was above the target object, behind the target object.

11. The method of claim 8, wherein rotating the target object to the substantially horizontal position includes:
holding the target object at an angle in the containment area with a top side of the target object near a back of the containment area and a bottom side of the target object off of the bottom of the containment area, wherein one pusher pad arm is above the other pusher pad arm and the lower pusher pad arm is under the target object;
rotating the bottom side of the target into a bottom corner of the containment area by rotating one of the pusher pad arms slightly downwards while maintaining pressure on the target object;
rotating the pusher pad arms, while holding the target object, from the back of the scoop to the front of the scoop;
extending the pusher pad arm that is under the plate towards the front of the scoop until it is no longer under the target object;
tilting the scoop forward to move the target object towards the front of the scoop; and
placing the pusher pad arm that was above the target object, behind the target object.

12. The method of claim 3, opening the access panel using the gripper arm;
partially pulling out the storage platform from the destination using the gripper arm;
extending the pusher pads out and forward with respect to the pusher pad arms;
rotating the first pusher pad inward toward the front edge of the scoop;
approaching the target object and coming to a stop when the target object is positioned below and between the pusher pads, wherein the target object is a plurality of cutlery items;
lowering the pusher pads to place the target object in contact with at least one of the first pusher pad and the second pusher pad;
rotating the second pusher pad or the first pusher pad until both the second pusher pad and the first pusher pad contact the target object;
lifting the target object up from the storage platform to a height of the containment area;
retracting the pusher pad arms to move the target object into the containment area; and
exerting pressure on the target object with the pusher pads to hold the target object stationary in the containment area; and
raising at least one of the scoop, the pusher pads, and the lifting column linear actuator, holding the target object, to the carrying position;
on condition the target object remains held between the pusher pads:
transporting the target object to a second destination;
on condition the target object does not remain held between the pusher pads:
tilting the scoop backwards;
releasing the target object from the pusher pads and into the scoop; and
transporting the target object to the second destination;
placing the containment area near a target surface of the second destination;
releasing the target object onto the target surface of the second destination by at least one of:
moving the target object to a position over the target surface by extending out the pusher pads and releasing the target object from the pusher pads resulting in unsorted cutlery items; and
tilting the scoop downwards towards the target surface of the second destination resulting in the unsorted cutlery items; and
removing the containment area from second destination.

13. The method of claim 12, further comprising:
orienting the tidying robot so that is can travel parallel to the target surface, wherein the target surface is a sorting surface;
rotating the scoop to a position over the sorting surface;
lifting one pusher pad slightly off the sorting surface, leaving a gap with enough space for unsorted cutlery items to fit through;
driving along an edge of the sorting surface spreading out the unsorted cutlery items including a plurality of individual pieces of different types of cutlery items;
repeating driving along the edge of the sorting surface until the unsorted cutlery items are sufficiently spaced to allow for isolating individual pieces of the plurality of individual pieces;
placing the pusher pads into a V-shape to create an opening between the pusher pads;
placing the opening in a position where at least a portion of a first individual piece of cutlery is in the opening, wherein the first individual piece of cutlery is a first type of cutlery;
moving the first individual piece of cutlery into the scoop by using the pusher pads;
placing the pusher pads into the V-shape to create the opening between the pusher pads;
placing the opening in the position where at least a portion of a second individual piece of cutlery, which is the first type of cutlery; is in the opening;
moving the second individual piece of cutlery into the scoop by using the pusher pads.

14. The method of claim 13, further comprising:
transporting the first and second individual pieces of cutlery to a cutlery tray, wherein the cutlery tray has individual tray slots for different types of cutlery items including a first tray slot for the first type of cutlery;
aligning the scoop with the tray slot for the first type of cutlery;
placing the pusher pads in a V-shape with an opening between the tips no larger than a width of the first tray slot;
tilting the scoop forward to allow a portion of the first cutlery to fall into the first slot;
moving the scoop backwards from the cutlery tray while slightly increasing an angle of the scoop tilt downward, directing the cutlery into the first tray slot;
continuing to move backwards and tilting the scoop forward until all of the first cutlery is in the first slot.

15. The method of claim 13, further comprising:
transporting the first and second individual pieces of cutlery to a cutlery tray, wherein the cutlery tray has individual tray slots for different types of cutlery items including a first tray slot for the first type of cutlery;
configuring the first pusher pad arm to a first extension where the first pusher pad is flat against a front edge of the scoop and configuring the second pusher pad arm to a second extension where the second pusher pad is at an angle to the first pusher pad when the tips of the first pusher pad and second pusher pad are in contact with each other, wherein the second extension is shorter than the first extension;
tilting the scoop back to move the cutlery items to the back of the scoop;
tilting the scoop forward to move the cutlery items to the front of the scoop, wherein the second pusher pad guides the cutlery items toward the first pusher pad;
aligning the portion of the front of the scoop with the first pusher pad arm next to a first longer side of the first tray slot while keeping the scoop tilted forward;
moving the first pusher pad forward to a second longer side of the first tray slot; and
allowing the cutlery items to fill into the first tray slot.
